(19) United States
(12) Patent Application Publication
(10) Pub. No.: US 2010/0185668 A1
(43) Pub. Date: Jul. 22, 2010

(54) Apparatuses, Methods and Systems for a Multi-Modal Data Interfacing Platform

(76) Inventor: Stephen Murphy, New York, NY (US)

Correspondence Address: CHADBOURNE & PARKE LLP, 30 ROCKEFELLER PLAZA, NEW YORK, NY, 10112, US

(21) Appl. No.: 12/596,637

(22) PCT Filed: Apr. 18, 2008
(86) PCT No.: PCT/US08/60841

§ 371 Date: Mar. 26, 2010

Related U.S. Application Data
(60) Provisional application No. 60/913,220, filed on Apr. 20, 2007.
(60) Provisional application No. 60/957,644, filed on Aug. 23, 2007.

(51) Int. Cl. G06F 17/30

(52) U.S. Cl. 707/771; 707/E17.014

(57) ABSTRACT

The present disclosure details apparatuses, methods, and systems for a Multi-Modal Data Interfacing Platform that bridges the divide between communication methods such as text messaging, instant messaging, email, voice telephony, and/or the like and data stores incorporated within databases, web servers, and/or the like. The Platform provides an interface whereby users may quickly and easily store and retrieve data via intuitive query strings. By connecting text and/or voice based communication with database and/or web content, Jotamo vastly expands the data processing capabilities of communication devices for which such content might otherwise be inaccessible.

### PRIORITY CLAIMS AND RELATED APPLICATIONS

Applicants hereby claim priority under 35 U.S.C. §119 for U.S. provisional patent application No. 60/913,220 filed Apr. 20, 2007, entitled, “APPARATUSES, METHODS AND SYSTEMS FOR A MULTI-MODAL DATA INTERFACING PLATFORM,” attorney docket no. 18471-002PV; and U.S. provisional patent application No. 60/957,644 filed Aug. 23, 2007, entitled, “APPARATUSES, METHODS AND SYSTEMS FOR A MULTI-MODAL DATA INTERFACING PLATFORM,” attorney docket no. 18471-002PV2.

The entire contents of the aforementioned applications are herein expressly incorporated by reference.

### FIELD

The present invention is directed generally to apparatuses, methods, and systems of data processing, and more particularly, to apparatuses, methods and systems for a multi-modal data interfacing platform.

### BACKGROUND

Modern communication methods such as text messaging, instant messaging, and email are increasingly ubiquitous. Today's mobile device technologies allow for many of these communication methods to be employed regardless of a user's location, as long as there is an available viable data link connection. Furthermore, the internet, and more particularly, the World Wide Web has expanded in information offerings and in use. Numerous information providers exist on the World Wide Web and are readily available to users through web browsers on personal computers.

### SUMMARY

This disclosure details the implementation of apparatuses, methods, and systems for a multi-modal data interfacing platform, which will hereafter be referred to by its proprietary moniker, Jotamo. Jotamo bridges the divide between communication methods such as text messaging, instant messaging, email, voice telephony, and/or the like and data stores incorporated within databases, web servers, and/or the like, providing an interface whereby users may quickly and easily store, query, and/or retrieve data via intuitive query strings. By connecting text and/or voice based communication with database and/or web content, Jotamo vastly expands the data processing capabilities of communication devices for which such content might otherwise be inaccessible. For example, in one embodiment, Jotamo allows cellular phones with no internet connection to send and receive information to and from the internet via voice or text messages. Jotamo may be configured in one embodiment to allow users to store simple, short notes in a general user storage area or structured notes in a user note storage hierarchy. Jotamo may also be configured in another embodiment to parse structured user input, submit data retrieval queries, and parse and/or package received data for sending back to the user.

In one embodiment, a method is disclosed for receiving a user input information, the user input information including at least a user identification information and a user query string; parsing the user query string into a plurality of user query tokens; querying a user profile based on the user identification information; classifying the user query string into at least one user query type based on at least one user query token; storing at least one user query token in a query type repository within the user profile based on the at least one user query type; selecting a query type data repository based on the at least one user query type; generating a requested data lookup query based on at least one user query token and the at least one user query type; submitting the requested data lookup query to the query type data repository; receiving a requested data output from the query type data repository based on the submitted requested data lookup query; packaging the requested data output; and sending the requested data output to a user display device.

### BRIEF DESCRIPTION OF THE DRAWINGS

The accompanying appendices and/or drawings illustrate various non-limiting, example, inventive aspects in accordance with the present disclosure:

FIG. 1 shows data flow between various entities comprising and/or in communicative contact with Jotamo in one embodiment of Jotamo operation;

FIGS. 2A-H shows certain implementations of user data inputs and system operation within embodiments of the Jotamo system;

FIGS. 3A-D show implementations of data structures directing Incoming Processing Server activity in one embodiment of Jotamo operation;

FIGS. 4A-C show logic flow for implementations of Incoming Processing Server operation in some embodiments of Jotamo operation;

FIG. 5 shows logic flow for an implementation of Jotamite Processing Server operation in one embodiment of Jotamo operation.

FIG. 6 shows logic flow for an implementation of Interface Processing Server operation in one embodiment of Jotamo operation;

FIG. 7 shows data flow between various entities comprising and/or in communicative contact with Jotamo in another embodiment of Jotamo operation;

FIG. 8 shows data flow between various entities comprising and/or in communicative contact with Jotamo in another embodiment of Jotamo operation;

FIG. 9 is of a block diagram illustrating embodiments of the present invention of a Jotamo controller;

FIG. 10 shows an implementation of data tables in one embodiment of Jotamo operation; and

FIGS. 11A-J shows aspects of query processing in one embodiment of Jotamo operation.

### DETAILED DESCRIPTION

In order to address various issues such as those discussed above, the invention is directed to systems, methods and apparatuses configured to facilitate multi-modal data interfacing. It is to be understood that depending on the particular needs and/or characteristics of an input device, display device, data store, or system user, various embodiments of Jotamo may be implemented that enable a great deal of flexibility and customization. The instant disclosure discusses an embodiment of Jotamo within the context of accessing online data, and/or classifying and/or storing newly input data in a user-accessible data repository. However, it is to be understood that the system described herein may be readily configured/customized for a wide range of applications or implementations. For example, aspects of the Jotamo system may be adapted for use in providing remote control over and/or instructions for automated processes, robotic actions, and/or the like. It is to be understood that the Jotamo system may be further adapted to other data access or remote control applications.

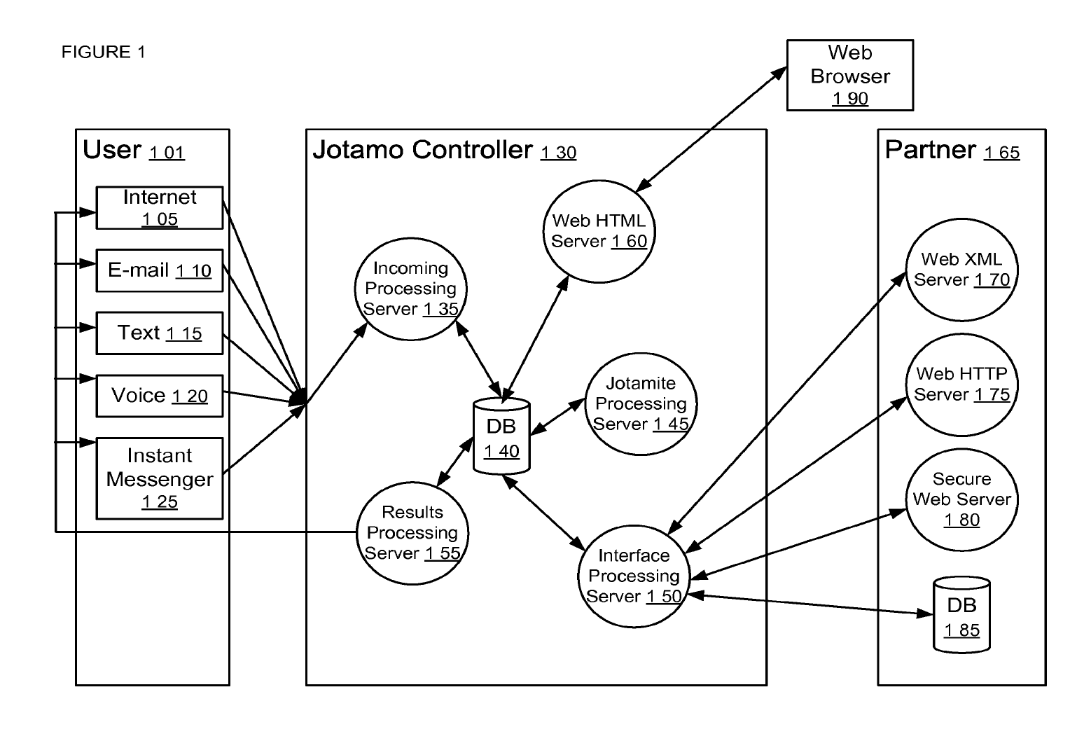

FIG. 1 shows data flow between various entities comprising and/or in communicative contact with Jotamo in one embodiment of Jotamo operation. A user 101 may be equipped with one or more data input and/or data display devices configurable to provide access to and/or via the internet 105, email 110, text messaging (e.g., SMS) 115, voice communications 120, instant messaging 125, and/or the like. The user 101 may employ one or more data input devices to send user data inputs to a Jotamo Controller 130. User data inputs may be submitted in a variety of forms, for example an email sent to a Jotamo email address, an SMS text message sent to a Jotamo message server, an instant message sent to a Jotamo message account, a voice message sent to a Jotamo answering service, and/or the like. Users may employ a wide variety of different data input devices, including Blackberrys, ordinary and cellular telephones, PDAs, Windows Mobile equipped mobile devices, laptop or desktop computers, Smartphones, handheld gaming consoles, Pocket PCs, and/or the like. Though an example of text messaging may be employed for illustrative purposes in the description below, it should be understood to be non-limiting, and any other of these or other similar data input devices may be employed to submit user input via any of the communication methods and protocols discussed herein. Received user data inputs may be relayed for initial processing to an Incoming Processing Server 135, which may perform initial analysis and/or classification of user inputs, and is coupled to send to and receive data from a Jotamo DB 140. The Jotamo DB 140 may contain user profiles, user input records, Jotamo output records, input and/or output classifications and/or hierarchies, data store and/or Partner 165 records and/or profiles, and/or the like, and may be further coupled to other modules within the Jotamo Controller 130. These include a Jotamite Processing Server 145, which may be configured to generate requested data lookup queries based on user inputs; an Interface Processing Server 150, which may be configured to push requested data lookup queries to data stores and/or a Partner 165 and receive and/or process requested data; a Results Processing Server 155, which may be configured to process and/or package requested data for output to users; and a Web HTML Server 160, which may be configured to interface with a web browser 190. The Jotamo Controller 130 may be coupled to one or more Partners 165, which may be comprised of data storage and/or collection agencies 185, websites, Web XML Servers 170, Web HTTP Servers 175, Secure Web Servers 180, and/or the like, to send requested data lookup queries and/or user information, receive requested data, and/or the like. Received data may then be processed by a Results Processing Server 155 for packaging and subsequent sending to a User 101 or user display device, which may be the same or different than the user input device. In one implementation, a user may specify that results be sent to other users and/or non-users. For example, a user submitting a user query string by email may carbon copy (CC) the email to other users. Jotamo may be configured to send the results of the user query string to the user and all users CC'd on the user email submission. In an alternative example, a user profile may specify a group to which all or particular data requests should be sent or made available.

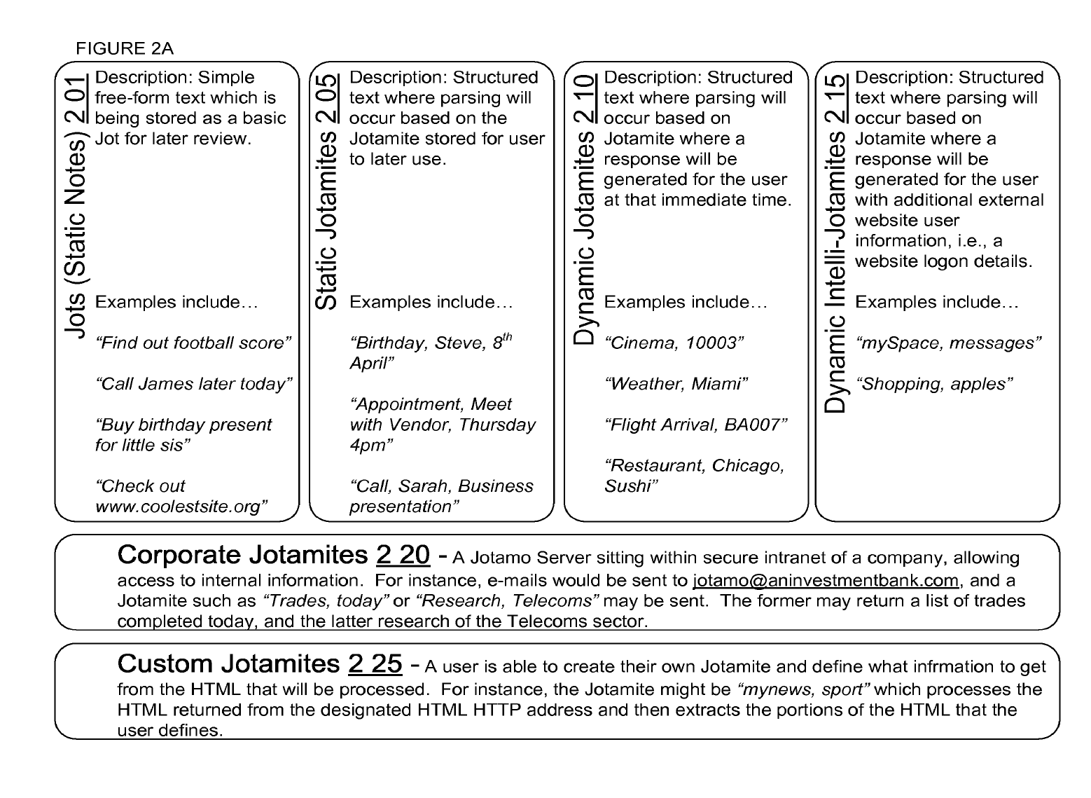

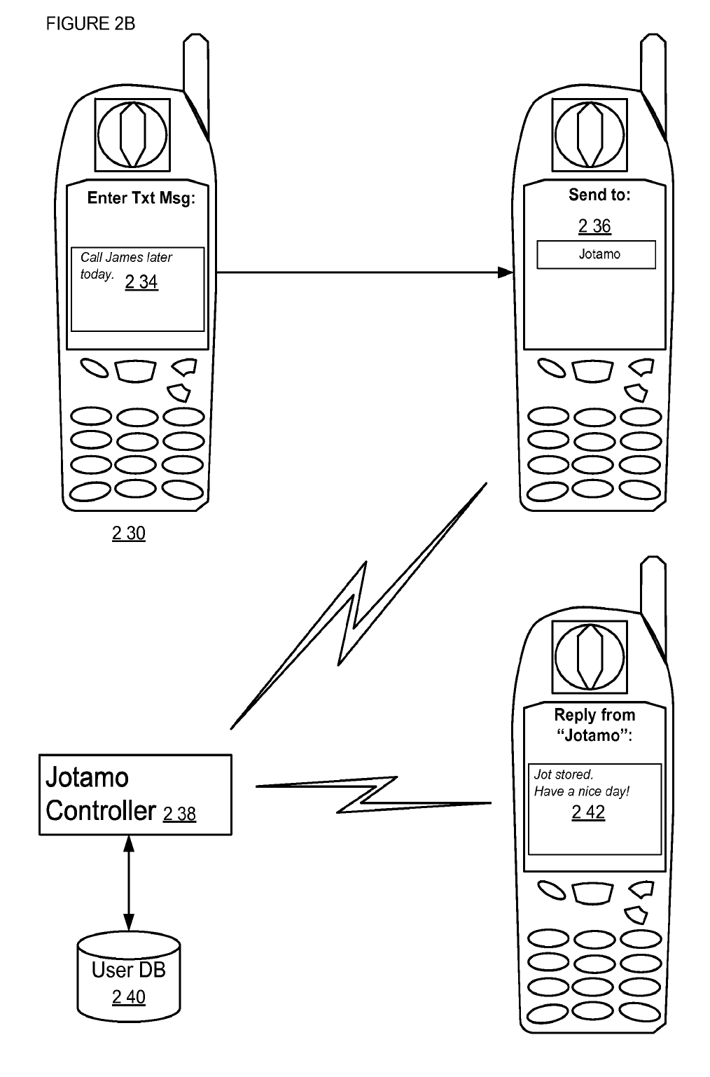

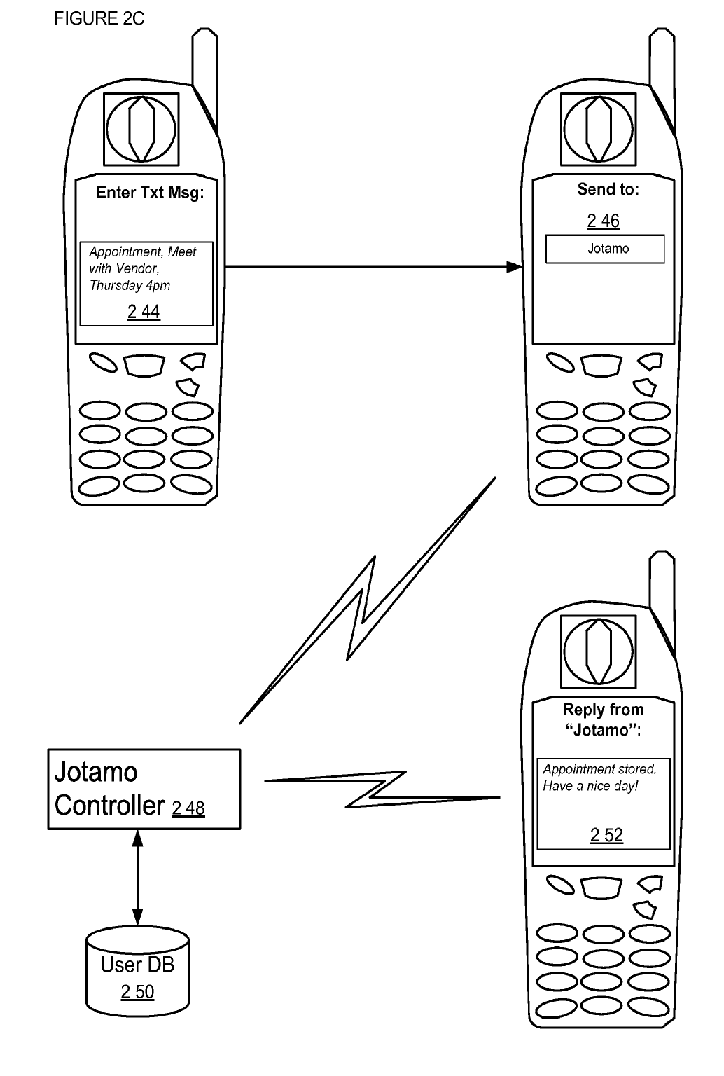

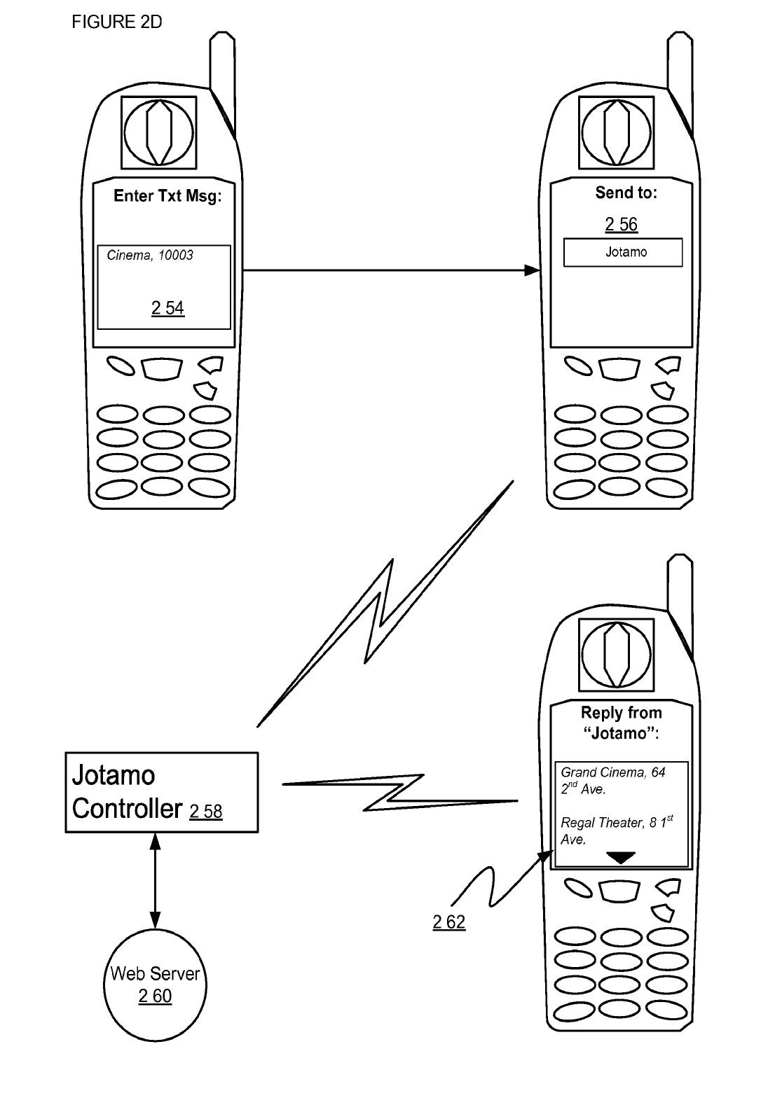

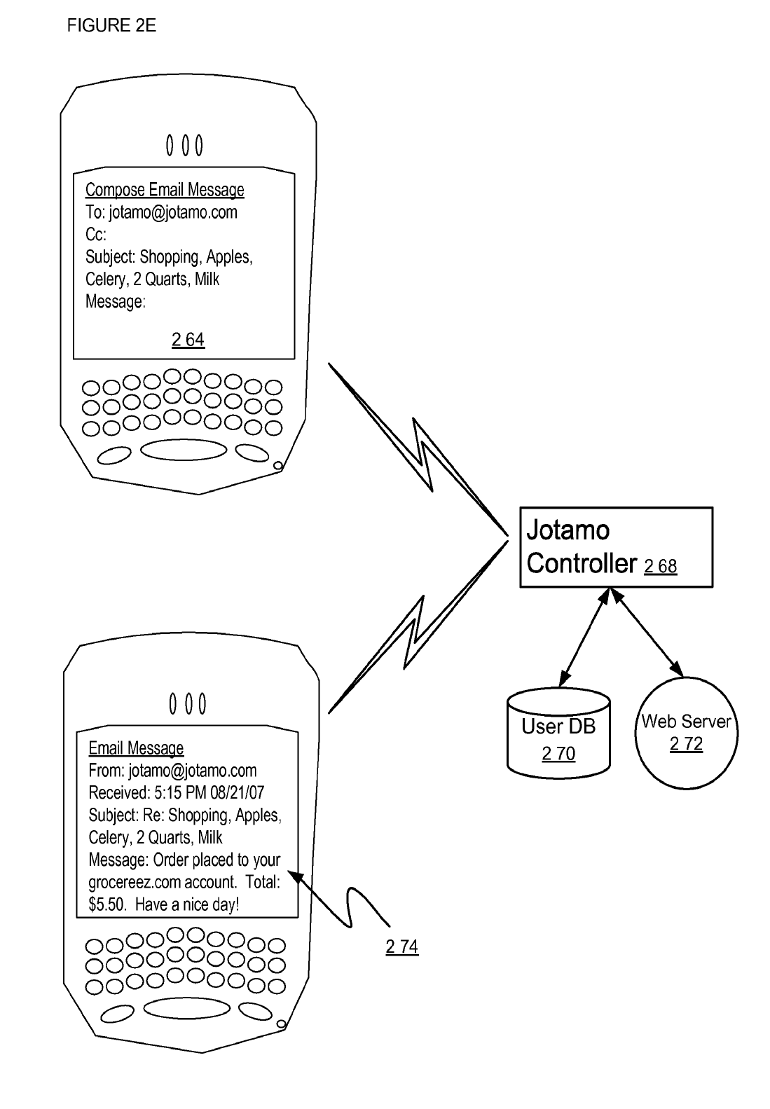

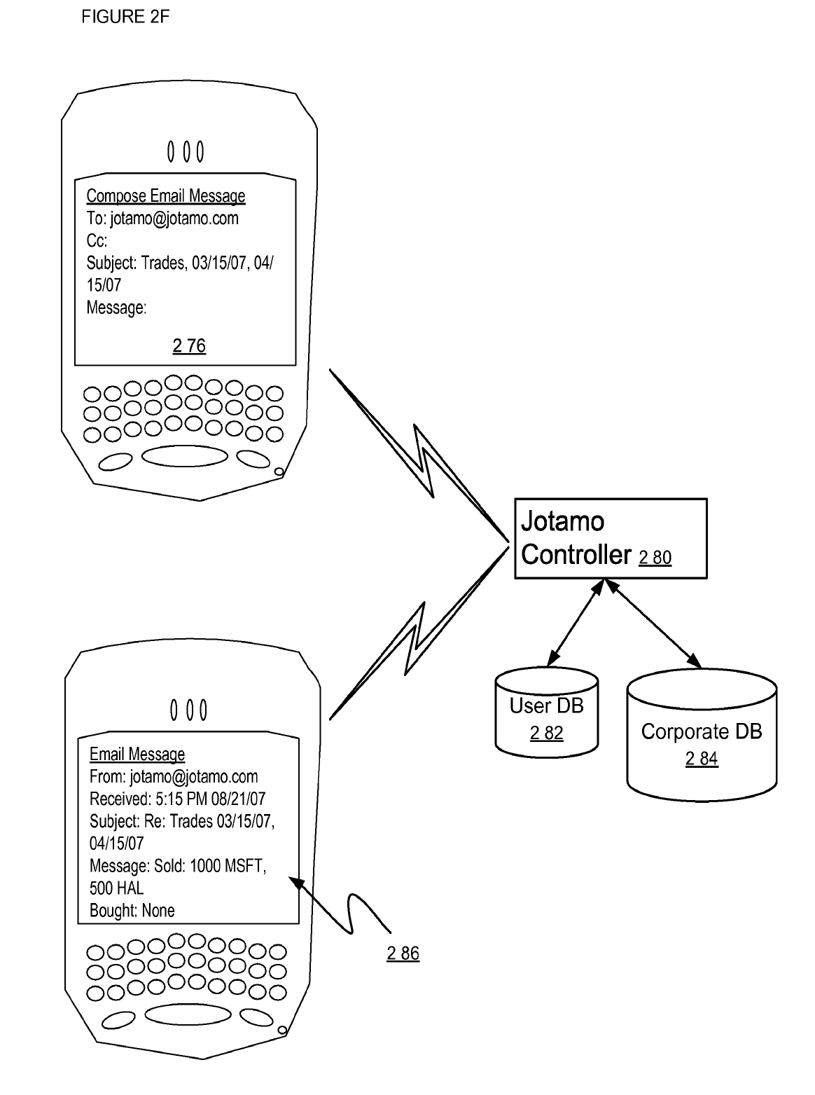

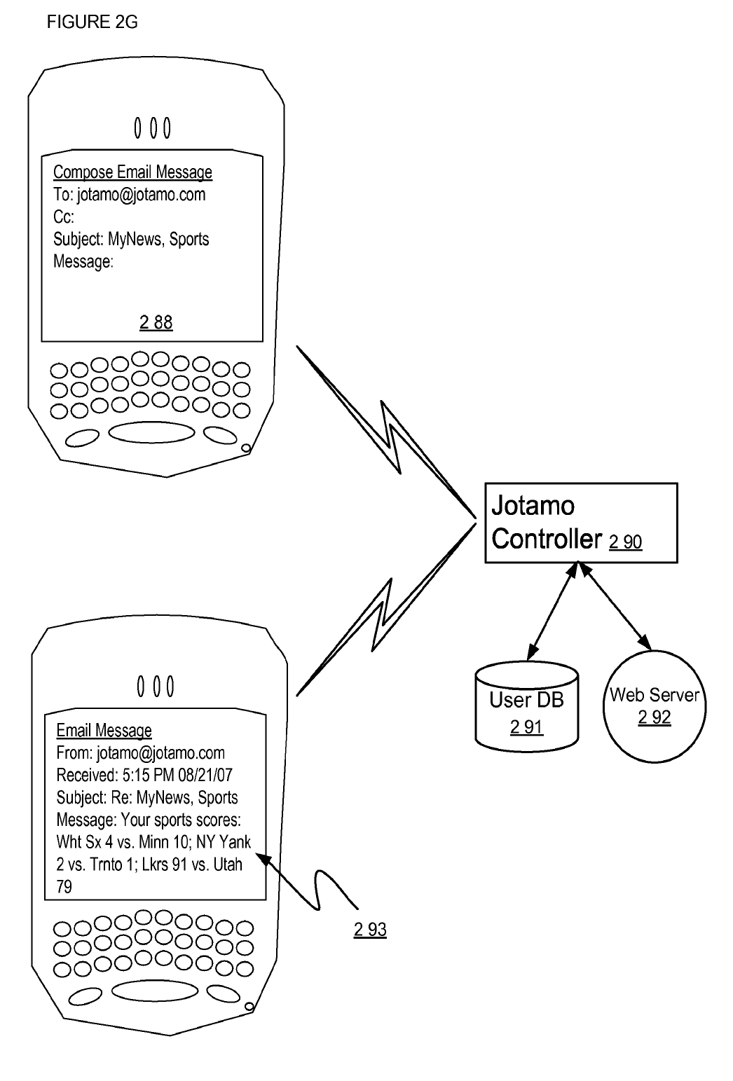

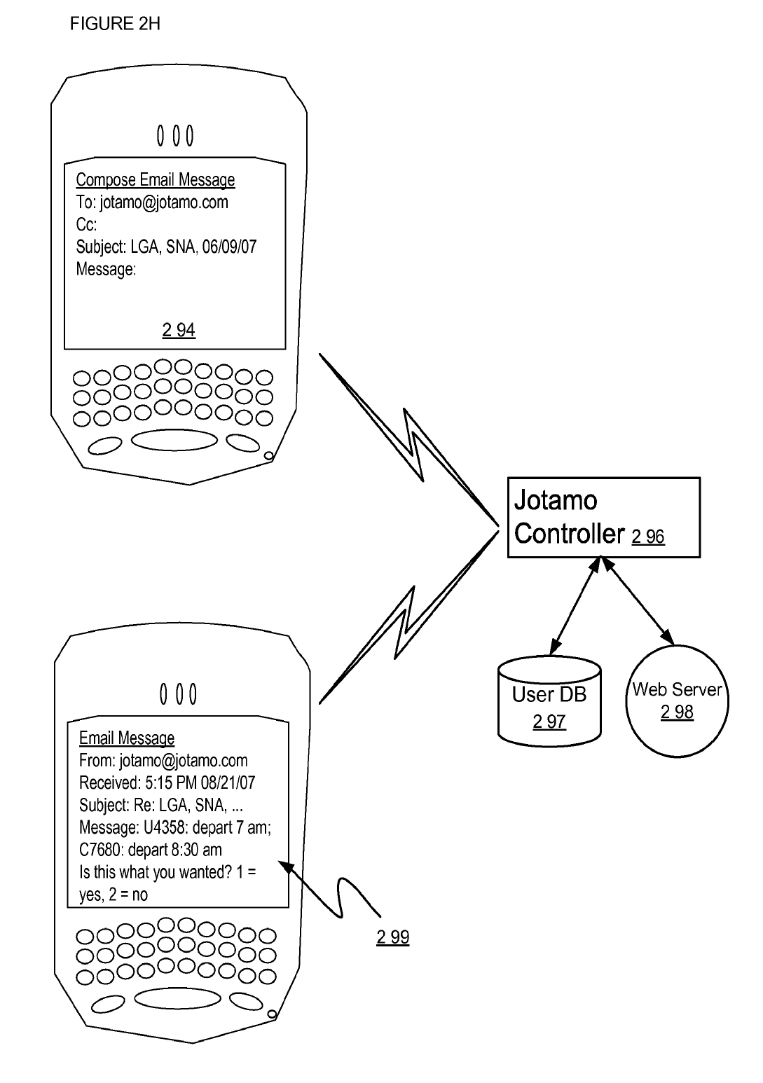

FIGS. 2A-H shows certain implementations of user data inputs and system operation within embodiments of the Jotamo system. Some possible input types are exhibited in FIG. 2A:

Static notes or “Jots” 201 are unstructured and/or free-form inputs. Jots may be stored “as is”, without further classification, for later retrieval and/or viewing by a user. An example of a Jot is the phrase, “Find out football score”.

Static Jotamites 205 are structured inputs that a user submits for later retrieval and/or viewing, but that may be parsed and/or classified within a data hierarchy based on tokens contained in the input. An example of a Static Jotamite is the string, “Birthday, Steve, 8^{th} April”. Jotamo may recognize this input as a Static Jotamite and save the name and date as a structured data unit within a birthday-specific dataset.

Dynamic Jotamites 210 are structured inputs that a user submits for receiving a data output response based on tokens contained in the input. An example of a Dynamic Jotamite is the string, “Cinema, 10003”. Jotamo may recognize this input as a Dynamic Jotamite constituting a query of cinemas in the 10003 zip code and may, consequently, generate a requested data lookup query to find, for example, a listing of cinema names in that zip code.

Dynamic Intelli-Jotamites 215 are structured inputs that a user submits for later retrieval and/or viewing and/or for receiving a data output response based on tokens contained in the input, wherein Jotamo further incorporates user identification information in a message to an external entity. An example of a Dynamic Intelli-Jotamite is the string, “mySpace, messages”. Jotamo may recognize this input as a Dynamic Intelli-Jotamite constituting a query of messages from the user's mySpace webpage and/or profile and may, consequently, generate a requested data lookup query, incorporating user login and/or password information, to retrieve the requested information for returning to the user. Another example of a Dynamic Intelli-Jotamite is the string, “Shopping, apples”. Jotamo may recognize this input as a Dynamic Intelli-Jotamite and access a user's online grocery shopping website profile (e.g., FreshDirect.com) to add “apples” to his or her stored shopping list.

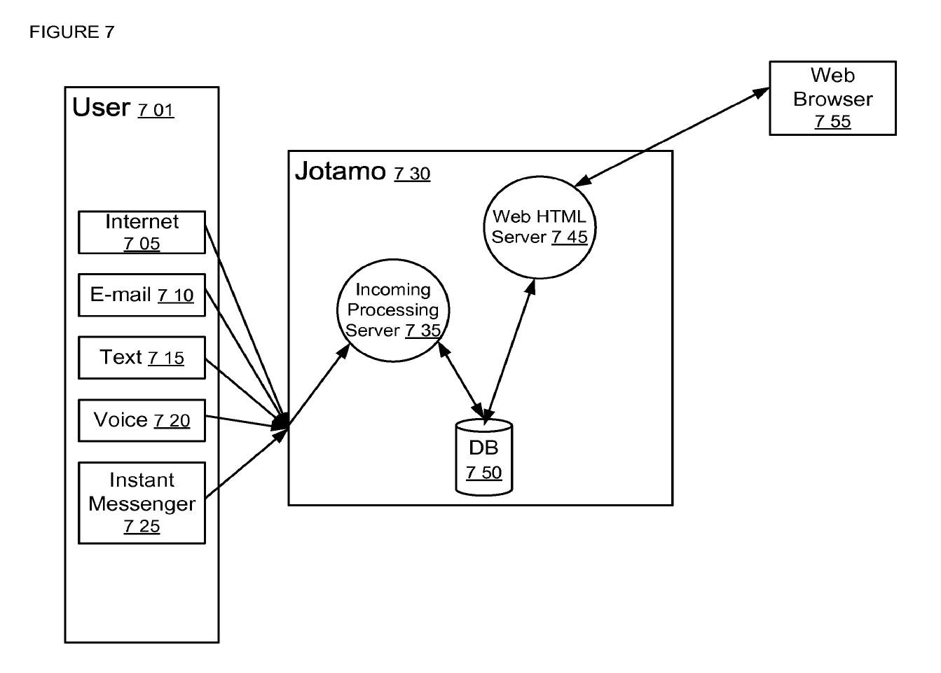

Corporate Jotamites 220 are inputs, structured or not, that are directed to and/or request information from the intranet, databases, web servers, and/or the like of a corporation, company, group, organization, and/or the like. Jotamo may recognize a corporate Jotamite based on a user input string, user identification information, and/or the address to which the user input string is sent (e.g., a Jotamo-specific email address on the corporate email server) and direct data storage and/or retrieval to a corporate server after verifying a user identification and/or password. An example of a Corporate Jotamite is the string, “Trades, today”, which may return a listing of securities trades made within the corporation during the present day. Further details related to Corporate Jotamites is included below with reference to FIG. 7.

Custom Jotamites 225 are structured inputs that a user submits to request information from one or more user specifies sources. Prior to submitting a custom Jotamite, a user may specify a particular information source (e.g., website, database, etc.) to which particular user input strings will refer and/or to which those strings should be directed. For example, a user may specify that the string “mynews, sport” should be directed to the sports page of cnn.com and return a listing of current sports scores. Subsequent submission to Jotamo of that string by that user will, consequently, retrieve and produce data from the specified source.

FIGS. 2B-D exhibit diagrammatic representations of interactions with Jotamo and Jotamo operation in the guise of SMS text messages submitted from a cell phone and FIGS. 2E-H exhibit the same in the guise of emails submitted from a Blackberry. In FIG. 2B, a user utilizes his or her cell phone 230 to enter a query string 234, in this case comprised of the simple Jot, “Call James later today.” When prompted to enter a send-to designation, the user enters a number, code, text string, and/or the like corresponding to the Jotamo system 236. The Jotamo controller 238 receives and processes the query string in conjunction with a user database 240 to store the simple Jot. In one implementation, the user may receive a confirmation notice 242 in reply to his or her submission.

FIG. 2C illustrates a situation in which a user submits a static Jotamite consisting of a structured query string intended for storage in the user profile. In this case, the user enters a string corresponding to an appointment 244, and provides the Jotamo address for the message's destination 246. The Jotamo controller 248 stores the static Jotamite in the appropriate table within the user profile and/or database 250 and returns a confirmation message 252.

FIG. 2D illustrates a situation in which a user submits a dynamic Jotamite consisting of a structured query string intended to trigger retrieval of some desired data and/or achievement of some desired action. In this case, the user enters a string corresponding to a query of local cinemas 254, and provides the Jotamo address for the message's destination 256. The Jotamo controller 258 receives the dynamic Jotamite and retrieves the requested data from a web server 260. The retrieved data is used to populate a message that is returned to the user 262.

FIG. 2E illustrates a situation in which a user submits a dynamic intelli-Jotamite consisting of a structured query string intended to trigger retrieval of some desired data and/or effectuation of some desired action. In this case, the user enters a string corresponding to a shopping list with items that may be purchased from an online grocer in the subject header of an email message, and provides the Jotamo email address for the message's destination 264. The Jotamo controller 268 receives the dynamic intelli-Jotamite along with user identification information (e.g., a user device hardware ID, password, and/or the like) and processes them in conjunction with a user profile, such as may be stored in a user database 270, in order to retrieve the desired information and/or effectuate the desired action via a web server 272. In this example, the web server allows the Jotamo controller 268 to submit a shopping request to a shopping website, here grocereez.com, on behalf of the user. The user, in return, receives a reply email containing a confirmation and some information related to the purchase 274. In an alternative implementation, the system may return the price to the user and request a confirmation to submit the purchase.

FIG. 2F illustrates a situation in which a user submits a corporate Jotamite consisting of a structured query string intended to trigger the retrieval of data and/or the effectuation of some desired action related to a corporate computer system. In this case, the user enters a query string requesting a listing of stock trades made over a specific range of dates in the subject header of an email message, and provides the Jotamo email address for the message's destination 276. The trades in question may, for example, be stock trades made by the corporation as a whole or they may be stock trades made by the individual user but only accessible through the corporate computer system. The Jotamo controller 280 receives the corporate Jotamite along with user identification information (e.g., a user device hardware ID, password, and/or the like) and processes them in conjunction with a user and/or corporate profile, such as may be stored in a user 282 and/or corporate database 284, in order to retrieve the desired information and/or effectuate the desired action. In this case, the Jotamo controller 280 retrieves the requested stock trades and delivers them as a reply email message to the user device for display 286.

FIG. 2G illustrates a situation in which a user submits a custom Jotamite consisting of a structured query string intended to trigger the retrieval of data and/or the effectuation of some desired action based on user-defined associations. In this case, the user enters a query string designed to return data that the user has previously designated as retrievable by this string in the subject header of an email message 288. In this case, the string is designated to retrieve scores from games involving the user's favorite sports teams. The user submits the query to the Jotamo email address, and the Jotamo controller 290 receives and processes the query in conjunction with a user database 291 and a web server 292 to retrieve the requested scores, which are returned as a reply email message for display on the user's device 293.

FIG. 2H illustrates a situation in which a user submits an ambiguous Jotamite, consisting of a structures query string that the Jotamo system must identify and/or disambiguate. In this case, the submitted string consists of three tokens separated by commas included in the subject header of an email message 294. The user submits this query string to the Jotamo email address, and the Jotamo controller 296 receives and processes the query string in conjunction with a user database 297 and/or a web server 298 to identify the nature of the request and to retrieve any desired data and/or effectuate any desired action. Here, the Jotamo controller 296 may identify the first two query tokens as airport codes corresponding respectively to La Guardia airport in New York, N.Y. and John Wayne Airport in Santa Ana, Calif., and the third token as a date. Once these identifications are made, the Jotamo controller 296 may further identify the query string as a request for flight information. Consequently, it may retrieve such information and provide it to the user's device as a reply email message for display 299, along with a confirmation message for the user to confirm or dispute whether the retrieved information is that which the user was seeking.

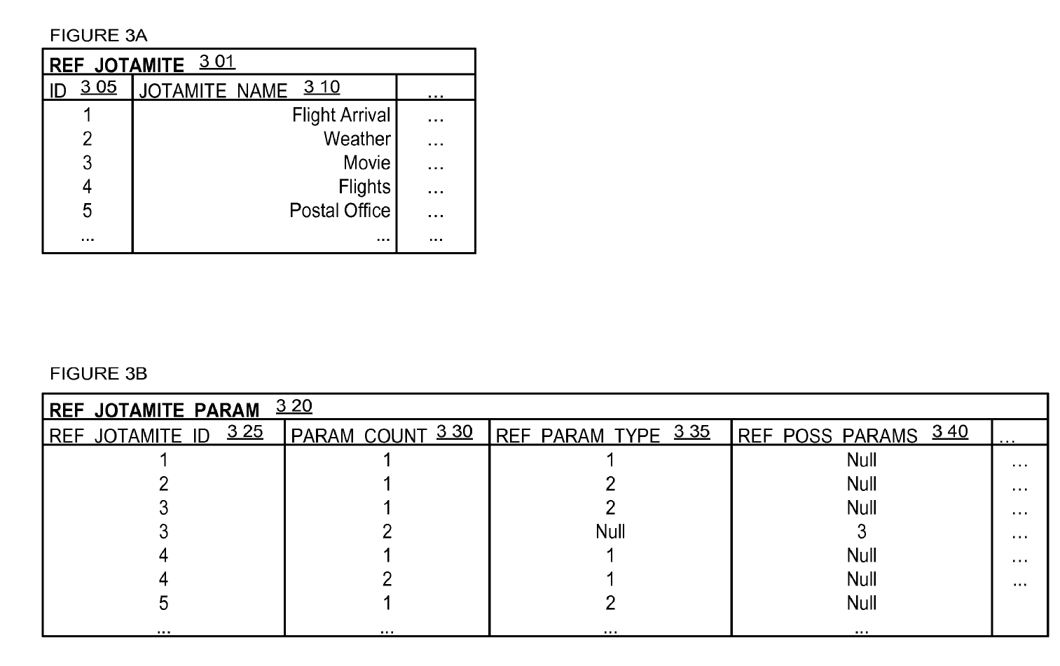

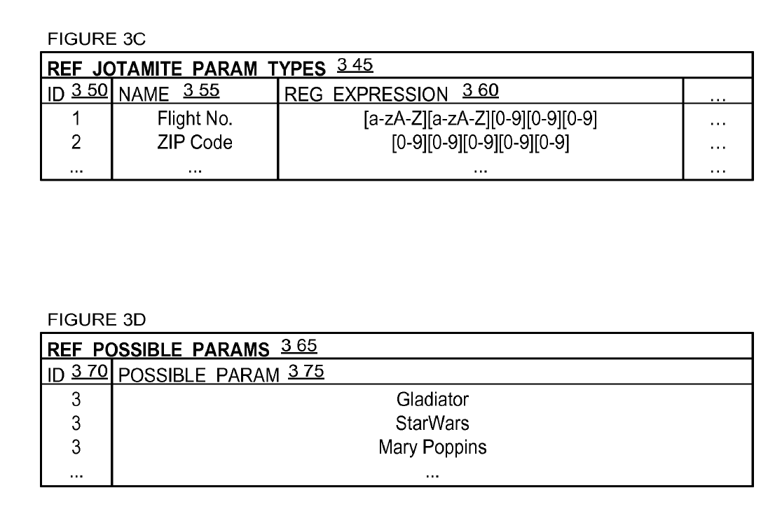

FIGS. 3A-D show implementations of data structures directing Incoming Processing Server activity in one embodiment of Jotamo operation. FIG. 3A shows a Ref_Jotamite table 301 that holds reference data defining the various classes of Jotamites. The table includes a Jotamite ID column 305, providing a unique identifier for each Jotamite, and a Jotamite name column 310. The Jotamite names listed in this latter column define the input tokens that, when present in a user query string, serve to identify the intent of the query and direct further query string processing. For example, a user query string containing the token “Flight Arrival” would be identified by Jotamo and classified with the Jotamite ID “1” for subsequent processing.

FIG. 3B shows a Ref_Jotamite_Param table 320 that holds the number of parameters a search uses and the cross references to the date types or possible values. A Ref_Jotamite_ID column 325 lists the associated mapping to the original search string entered (i.e., the first column 305 of the Ref_Jotamite table 301 in FIG. 3A). A Param_Count column lists the number of parameters for the search corresponding to the Jotamite. For example, the “Flight Arrival” Jotamite has a Param_Count value of 1, which suggests that only one parameter (e.g., a flight number) needs to be specified in order to conduct a Flight Arrival search and return a result. The identity of the expected parameter type is listed in the Ref_Param_Type column 335, which lists ID numbers referencing entries in the Ref_Jotamite_Param_Types table 345 displayed in FIG. 3C. The Ref_Jotamite_Param table 320 also includes a Ref_Poss_Params column 340, which lists ID numbers referencing entries in the Ref_Possible_Params table 365 displayed in FIG. 3D, thereby associating Jotamites with defined sets of possible parameters when appropriate.

FIG. 3C shows a Ref_Jotamite_Param_Types table 345 that stores the data types and regular expressions encoding for those data types. An ID column 350 lists unique ID numbers identifying the parameter data types. A Name column 355 lists the names of the data types (e.g., Zip Code, Bar Code, ISBN Number, etc.). A Reg_Expression column 360 lists entries that specify the format, in regular expression notation, expected for each parameter type. For example, a zip code has five decimal digits, and may therefore have a regular expression format listed as “[0-9][0-9][0-9][0-9][0-9]”.

FIG. 3D shows a Ref_Possible_Params table 365 that stores the possible parameter entries for a given search or parameter. An ID column 370 lists unique ID numbers identifying the parameters. A Possible_Param column 375 lists actual possible parameter values for the search. In the example shown in the figure, the possible parameter values correspond to movie titles. These values may be employed within Jotamo's pattern matching system in order to choose the best match result. As opposed to the Ref_Jotamite_Param_Types table 345, which identifies the expected format of parameter entries, the Ref_Possible_Params table 365 may store lists of the expected entries themselves. For example, while an Airport Code entry in the Ref_Jotamite_Param_Types table 345 may have a Reg_Expression column 360 entry of “[A-Z][A-Z][A-Z]”, the Airport Code entry in the Ref_Possible_Params table 365 may have Possible_Param column 375 entries of “LGA”, “LAX”, “ORD”, “ATL”, etc. corresponding to actual airport codes that a user might enter.

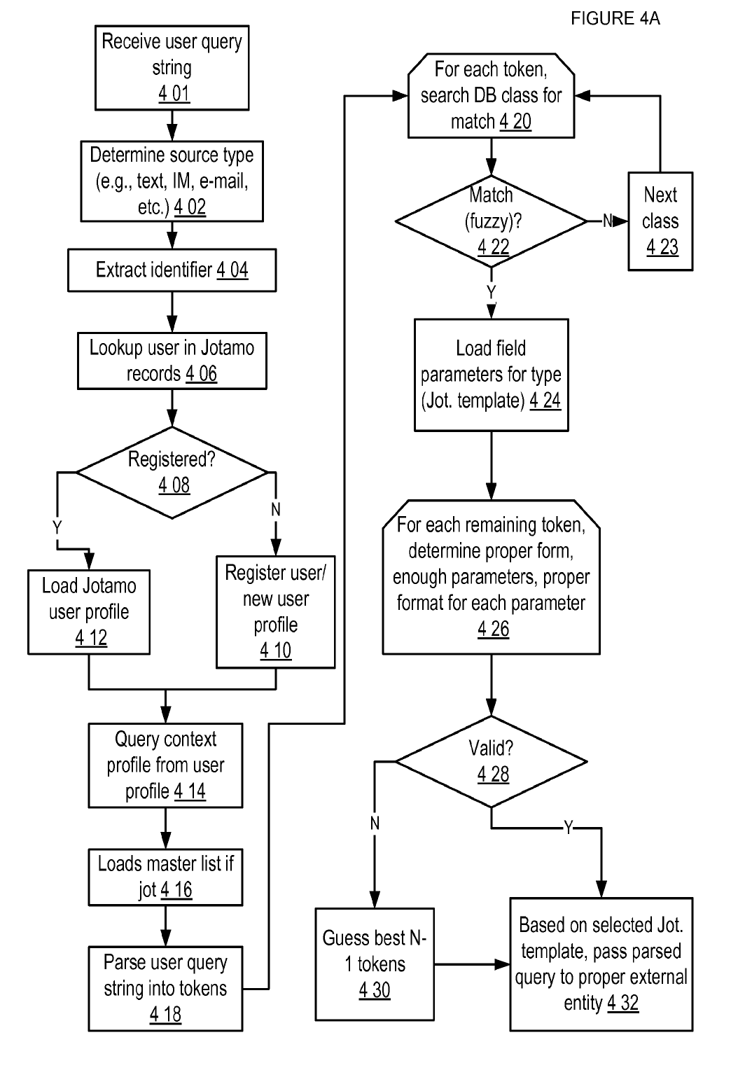

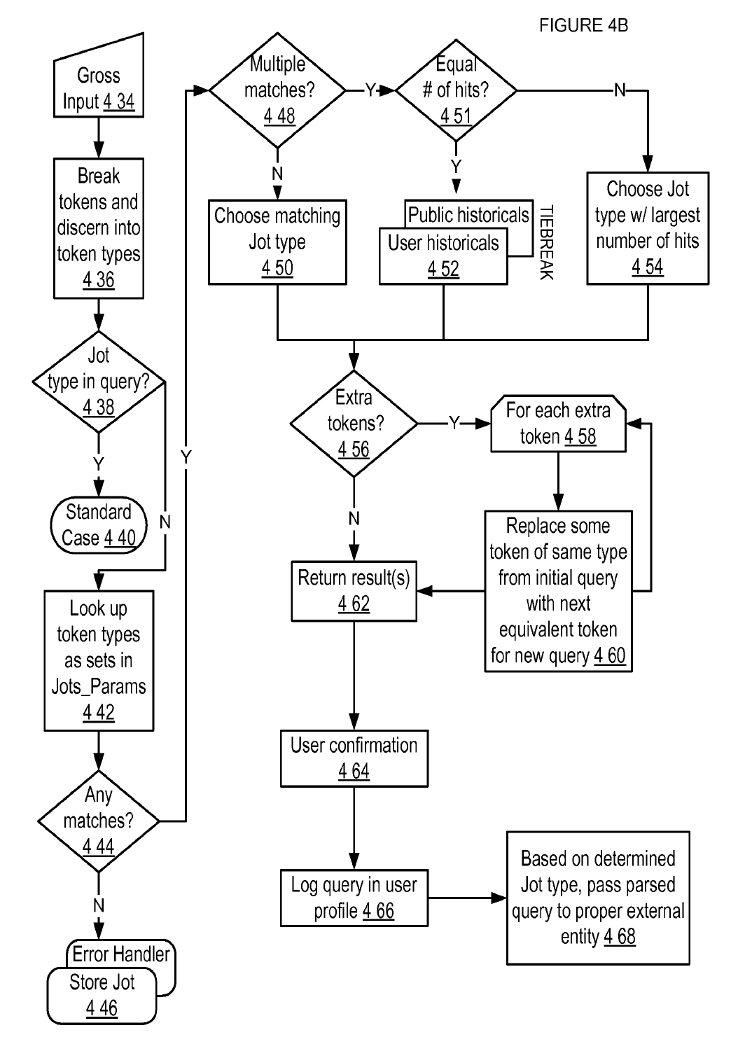

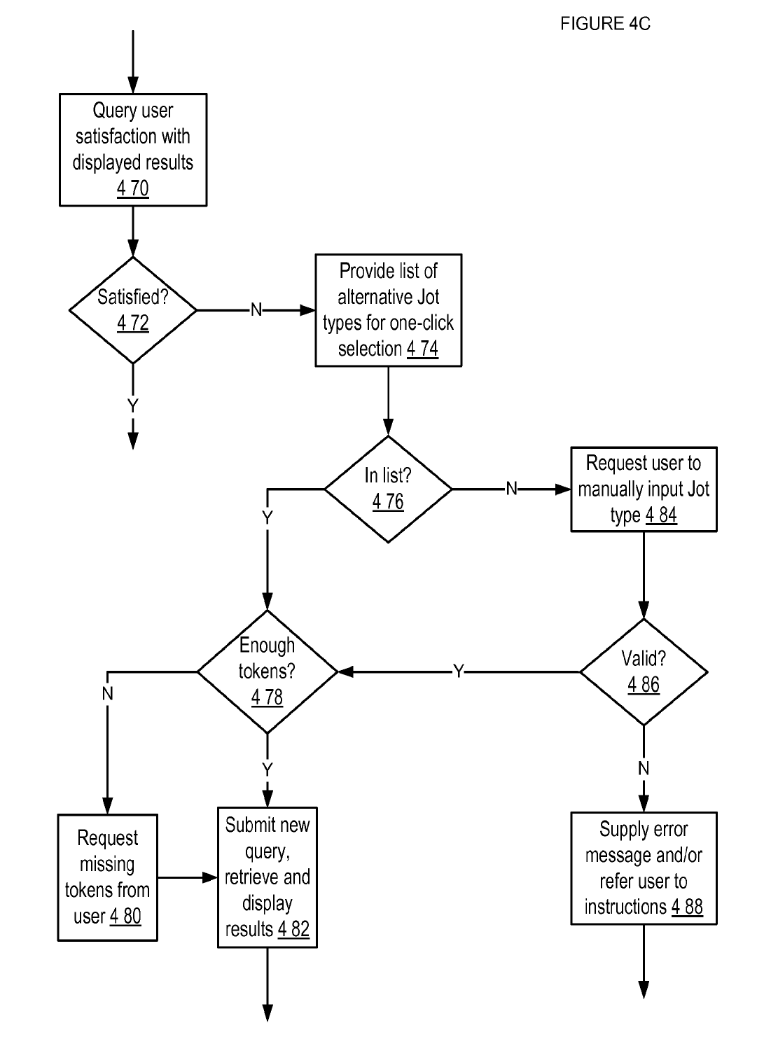

FIGS. 4A-C shows logic flow for implementations of Incoming Processing Server 135 operation in some embodiments of Jotamo operation. Throughout discussion of FIGS. 4-6, an example of a weather query may be used to illustrate aspects of Jotamo operation. It should be understood that this example is non-limiting and for illustrative purposes only. Referring to FIG. 4A, Jotamo receives a user query string at 401, which may take a variety of forms within various embodiments, including text messages, instant messages, emails, voice messages, and/or the like. The user may send a user query string from any of a number of user input devices (e.g., cell phone, telephone, Blackberry, PDA, laptop or desktop computer, portable IM/text message/email device, and/or the like) that may or may not have internet connections. Users may send a user query string to a Jotamo-associated address, such as an email address, telephone number, instant message ID, and/or the like, from which the user query string may be relayed to Jotamo modules for subsequent processing. For example, a user may send the string “Weather, Miami” via a text message to a Jotamo-affiliated message server. At 402, Jotamo may determine the source type corresponding to the specific user input device or class of devices (e.g., text message), and may extract a user and/or hardware identifying information at 404. Jotamo may perform a lookup of user records 406 based on identifying information and determine whether or not a given user is registered 408. If not, Jotamo may register the user and/or collect user information to generate a new user profile 410. Otherwise, Jotamo may load a user profile 412 corresponding to user identifying information. At 414, Jotamo queries a context profile corresponding to and/or associated with a user profile. A context profile may, for example, specify a user's geographic location (e.g., country, state, etc.), language, and/or the like, and interpret user query strings in light of those specifications. For example, a user's context profile may specify that he or she lives in Florida, and consequently that “Miami” in the user query string probably refers to Miami, Fla. and not, say, to Miami, OK or the city of Miami in Canada. This exemplary context profile may also inform the Jotamo system to express results in units familiar to the user (e.g., temperature in Fahrenheit, rainfall in inches, etc.). In alternative implementations, a context profile may specify corporate and/or user-specified templates, protocols, and/or the like in the context of Corporate and/or Custom Jotamites respectively. At 416, Jotamo loads a master list of stored Jots if the user query string is determined itself to be a Jot. Otherwise, structured user query strings are parsed into tokens at 418. Parsing may be performed based on the detection of separation indicators between user query string tokens, such as commas, semicolons, periods, spaces, front/back slashes, dashes, underscores, pauses, keywords, and/or other characters, punctuation marks, or elements of speech. For example, the user query string “Weather, Miami” might be parsed into tokens “Weather” and “Miami” based on the presence of an intervening comma. At 420, Jotamo searches a database class for each token and attempts to determine whether there exists a match for that token within the class 422. A match may be registered even if that match is “fuzzy” if the user query string token and the corresponding token in a database class are sufficiently close, and/or are different in a way that is recognizable by Jotamo modules. For example, database classes may contain a collection of tokens with various near misspellings, synonyms, homonyms, and/or the like in order to provide a range of possible matches for a given token and/or database class. In the example of the query string “Weather, Miami”, the Jotamo system may be configured, for example, to recognize the weather token even if the user had accidentally spelled it “Whether”, as this is a common misspelling that may be accounted for in Jotamo programming. If a match is not found within one database class, Jotamo proceeds to the next database class at 423 to check for a match therein. At 424, Jotamo loads field parameters corresponding to the identified user query string type and/or a corresponding Jotamite template, specifying properties of tokens that may be considered by the template in further processing. At 426, Jotamo inspects each remaining token and/or Jotamite template field to determine the extent to which Jotamite template fields may be populated with valid user query string tokens. A determination is made at 428 whether the Jotamite template population is valid and, if not, tokens corresponding to empty or invalid field entries are guessed at 430. Otherwise, the parsed query is passed to an appropriate module based on the selected Jotamite template at 432.

FIG. 4B shows an alternative embodiment of Incoming Processing Server 135 operation, whereby poorly structured or ambiguous user query strings may be disambiguated, parsed, processed, and/or the like. At 434, Jotamo receives a gross user input string, which may comprise a string of query tokens separated by separating characters, such as commas. At 436, these query tokens are broken apart and token types and/or characteristics are determined. Such determination and/or identification may, for example, be accomplished by recognizing token features, such as the number of characters in the token, the character order (e.g., a letter followed by several numbers, which may identify an airline flight number), and/or the like, associating recognized features with each token, comparing the token features to a token glossary that specifies the token features corresponding to a particular token type, labeling the token with the determined token type, and/or the like.

A determination is made at 438 as to whether or not any of the query tokens comprise a Jot type identifier by comparing each token and/or token type to a list of Jot type tokens (e.g., weather, flight, cinema, stock, any custom quotes, and/or the like). If a match is found, the flow proceeds according to the standard case relevant for that Jot type (e.g., to 424 in FIG. 4A). Otherwise, the flow proceeds to 442, where the token types identified in the query string are compared as a set to sets of expected token types corresponding to various Jot types. For example, a “flights” Jot type may have a corresponding expected token type set comprising two airport designation tokens and a date or time token. At 444, Jotamo determines whether a match was found between the query string's token type set and a Jot type token type set. If not, then the flow proceeds to 446 where Jotamo may store the query string as a Jot and/or refer the query string to an error handler to notify the user of an error, make suggestions on how to improve the error, refer the user to usage instructions, and/or the like.

If a match is found, on the other hand, then the flow proceeds to 448 where a determination is made as to whether multiple matches were found. If not, then Jotamo selects the single matching Jot type at 450. Otherwise, a determination is made at 451 as to whether the multiple Jot type matches each had an equal number of token type matches or hits. For example, a “weather” Jot type may admit a location and a date while a “flights” Jot type and a “sports score” Jot type may both admit two locations (i.e., the departure and arrival locations for a flight or the hometowns of two sport teams) and a date. A query string comprised of two location token types and one date token type may initially match all three of these Jot types. If there is a single Jot type with more token type matches than the others, it is selected at 454. If there is remaining ambiguity (e.g., “flights” and “sports score” in the previous example), then the flow proceeds to 452 where a “tiebreak” is performed to select from the remaining Jot types based on a history of Jot types queried by the user and/or by other users. For example, in one implementation, Jotamo may select a Jot type from the set of remaining possibilities that has been most commonly queried or selected by the user or other users. In another implementation, any remaining ambiguity may be resolved by selecting a single Jot type randomly from the remaining set of Jot types.

At 456, Jotamo may check whether extra tokens are present in the query string that are more than the expected number of tokens for the identified Jot type based on the expected token type set. If extra tokens are detected, then for each extra token 458, Jotamo replaces a token of the same token type in the query string and re-performs the query. For example, a query string with multiple location designations that has become associated with a “weather” Jot type, which may normally only admit one location token, may cause Jotamo to sequentially submit weather-related queries for each of the multiple locations. Results, whether single or multiple, are returned for display to the user at 462, and a user confirmation that the correct Jot type has been determined is solicited at 464. An elaboration of this user confirmation solicitation is provided in FIG. 4C. At 466, Jotamo may log the query in the user profile and, at 468, may pass the parsed query to the proper external entity based on the determined Jot type.

FIG. 4C shows logic flow in one implementation of user confirmation solicitation. At 470, Jotamo may query a user's satisfaction with results that have been returned and displayed to him or her. Such a query may comprise, for example, clickable selections (e.g., “Yes” or “No” hyperlinks) in an email, text message and/or instant message reply codes, telephone/voice menu options, and/or the like that allow Jotamo to determine whether or not the returned results conform to the user's expectations and/or desires 472. If the user is satisfied, then the user confirmation solicitation is complete. Otherwise, Jotamo may provide a list of alternative Jot types for one-click selection 474, such as based on the identification of possible Jot types from FIG. 4B. The one-click selection may comprise clickable selections of Jot types in an email, text message and/or instant message reply codes corresponding to various Jot types, telephone/voice menu options, and/or the like. A determination is made at 476 as to whether the desired Jot type exists in the list of alternatives and, if not, the user is requested to manually input the type of Jot he or she is seeking 484. At 486, Jotamo determines whether the manually entered Jot type is valid, such as by comparing it to a list of valid Jot types. If not, then an error message may be supplied and/or the user may be referred to a set of instructions for query string submittal 488. Otherwise, if either the manually entered query type is valid or the desired query type exists in and was selected from the provided list of alternative query types, then the flow proceeds to 478, where a determination is made as to whether the query string contains enough valid tokens for a query to be submitted. If not, Jotamo requests the user to enter the missing tokens at 480. If the required tokens are present, the valid query string is submitted, and results are retrieved and displayed at 482.

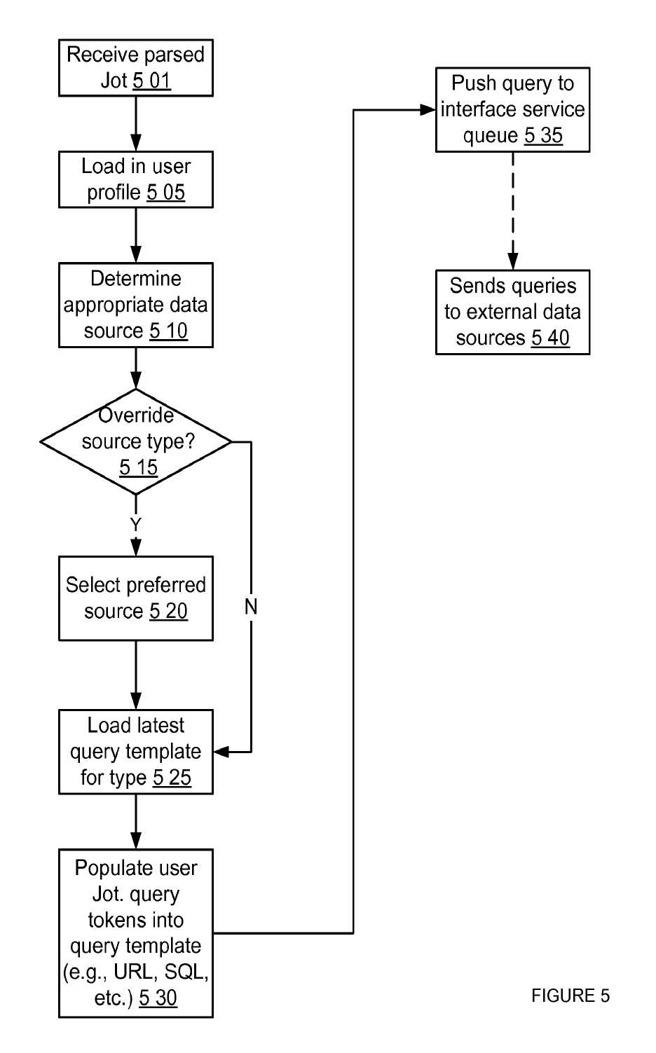

FIG. 5 shows logic flow for an implementation of Jotamite Processing Server 145 operation in one embodiment of Jotamo operation. A parsed Jot is received at 501 and loaded in a user profile at 505. A data source, for example the user data input device (e.g., text message), is determined at 510, and a determination is made at 515 as to whether to override the input source and choose an alternative, preferred source. If so, a preferred source is selected at 520. This selection may be pre-determined and stored in a user profile, or it may be made by a user in response to a choice offered to the user at the time of user query string submission and/or processing. At 525, Jotamo loads the latest query template corresponding to the Jotamite template type determined in FIG. 5. A query template may, for example, be comprised of a URL query, database query, SQL query, CQL query, and/or the like containing empty fields to be filled by tokens parsed from a user query string. In an example for a user query string of “Weather, Miami”, the query template may be http://www.weather.com/weather/local/US?location=/, where the blank field between the equals sign and the last slash may be populated with a location token from the user query string. Template fields are filled with user query string tokens (e.g., Miami) at 530, and the completed data request queries are pushed to an interface service queue at 535. Data request queries may optionally be further sent to external data sources at 540 to retrieve requested data therefrom and/or generate actions therein. In one implementation, tokens gleaned from user query strings may be altered and/or augmented prior to insertion into query templates. Such alteration may be directed by the user profile, the context profile, partner data request requirements, and/or the like.

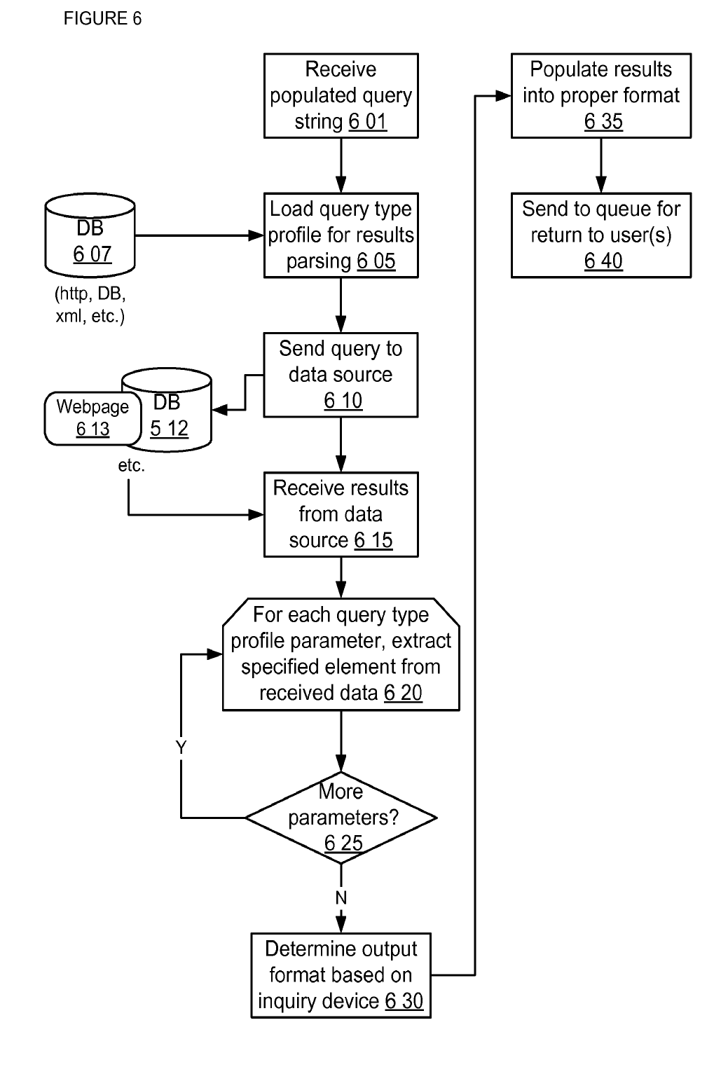

FIG. 6 shows logic flow for an implementation of Interface Processing Server 145 operation in one embodiment of Jotamo operation. A data request query populated with tokens from a user query string is received at 601. Jotamo may then load a data request query type profile 605 from a query type database 607, which may direct and/or instruct parsing of resulting data returned from various external entities. For example, a data request query type profile corresponding to a weather query may specify that current temperature, humidity, and pressure should be returned to the user. At 610, a data request query is sent to one or more data sources (e.g., databases 612, webpages 613, and/or the like) and results are received from the data source at 615. At 620, a specified data element may be extracted from the received data for each listed parameter in the data request query profile, and proceeds until there are no further parameters 625. Jotamo may recognize the required data elements in the retrieved data based on data identifiers, tags, surrounding text, position within the page, and/or the like. At 630, Jotamo determines the format based on an inquiry device, which may correspond to the user input device or an alternative specified user display device. At 635, results are populated into the determined, proper format and sent to a queue for return to one or more users at 640.

FIG. 7 shows data flow between various entities comprising and/or in communicative contact with Jotamo in another embodiment of Jotamo operation. In this embodiment, a user 701 may submit a Jot, via a variety of data submission protocols, methods, and platforms (e.g., internet 705, email 710, text message 715, voice message, 720, instant message 725, and/or the like), to Jotamo 730 for storage and later retrieval. Data received from the user may be initially received and/or processed in an Incoming Processing Server 735, coupled to a Jotamo database 750. The database is also communicatively coupled to a Web HTML Server 745, which may provide Jots and/or other information at a later time to a Web Browser 755.

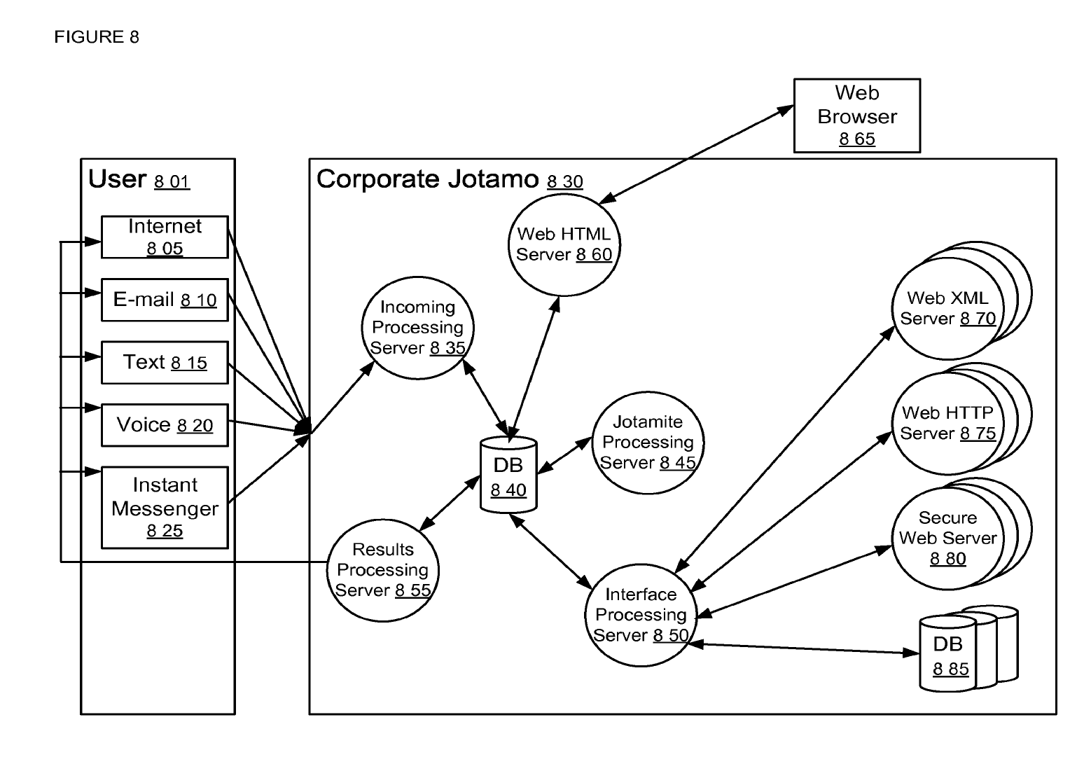

FIG. 8 shows data flow between various entities comprising and/or in communicative contact with Jotamo in another embodiment of Jotamo operation. In this embodiment, a user 801 may submit a Jot or Jotamite, via a variety of data submission protocols, methods, and platforms (e.g., internet 805, email 810, text message 815, voice message, 820, instant message 825, and/or the like), to a Corporate Jotamo 830 for storage and later retrieval or for requesting additional corporate data to be sent to them. Like embodiments shown in FIGS. 1 and 7, the Corporate Jotamo system 830 may include a number of modules such as Incoming Processing Server 835, Jotamo database 840, Jotamite Processing Server 845, Interface Processing Server 850, Results Processing Server 855, and Web HTML Sever 860 coupled to an external Web Browser 865. The Corporate Jotamo may further incorporate a collection of internal Web XML Servers 870, Web HTTP Servers 875, Secure Web Servers 880, and databases 885, providing access to secure, proprietary, and/or privileged data that may only be accessible by a select group of users.

### Various Applications

The Jotamo system provides an efficient and effective data conduit that may be applied to a wide variety of information storage, retrieval, and dispensation applications. In one embodiment, Jotamo may allow users to store notes and/or reminders for themselves or others.

In another embodiment, Jotamo may allow users to retrieve a variety of data on devices that may not otherwise have access to such data, such as devices that are not coupled to the internet or other data storage areas.

In another embodiment, Jotamo may allow group leaders (e.g., employers, managers, government officials, teachers, and/or the like) to provide subordinates (e.g., employees, students, workers, and/or the like) with a means to access, consult, and alter group records. Jotamo further facilitates group communication, allowing one or more user actions to result in information dissemination to other users and/or to alter information that other users may later consult.

In another embodiment, Jotamo may allow users to customize Jotamo modules such that a submitted user query string may access user-specified and/or created data sources for data retrieval. For example, Static Jotamites may form the basis for a custom data source to which a user may refer with future dynamic Jotamites.

In another embodiment, Jotamo may allow users to remotely control devices. A submitted user query string may specify a device and a set of instructions of what the device is to do. For example, a user query string may specify, “Security Cameras, Northwest Lawn, Begin Recording” to cause a specific security camera to begin recording video.

In another embodiment, a Jotamo operator may receive revenue directly from partners from which data is retrieved. For example, a payment may be made for each instance and/or collection of instances at which data is requested from the partner. In exchange, a Jotamo operator may note the data source in the reply sent to the user. In yet another embodiment, a Jotamo operator may receive a share of advertiser revenue from a partner's advertiser where data is retrieved. Advertising from these advertisers may be incorporated in a reply sent to the user. In yet another embodiment, a Jotamo operator may receive revenue from advertisers paying for specific types of data searches. For example, a travel agency may pay to have advertising included in reply messages sent to users submitting weather-related query strings. Advertising included in replies sent to users may be selected and/or modified based on a user query string, user profile, context profile, and/or the like.

### Jotamo Controller

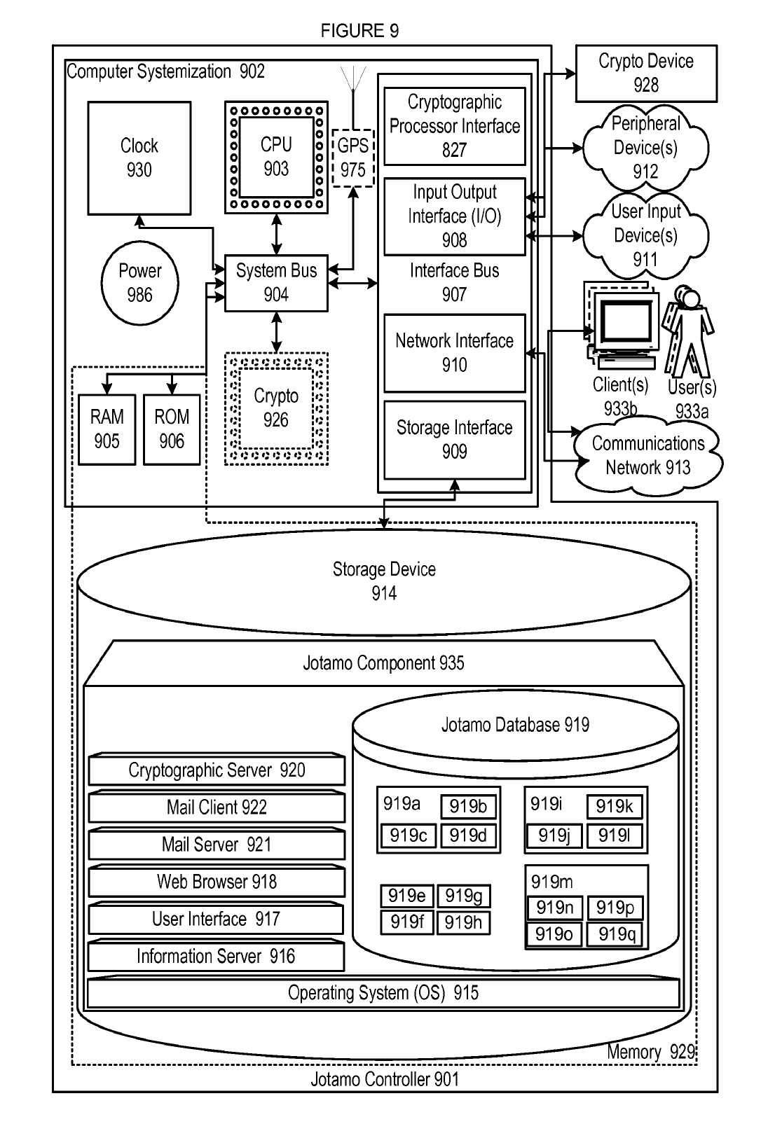

FIG. 9 of the present disclosure illustrates inventive aspects of a Jotamo controller 901 in a block diagram. In this embodiment, the Jotamo controller 901 may serve to aggregate, process, store, search, serve, identify, instruct, generate, match, and/or update databases, database elements, database element fields, and/or other related data.

Typically, users, which may be people and/or other systems, engage information technology systems (e.g., commonly computers) to facilitate information processing. In turn, computers employ processors to process information; such processors are often referred to as central processing units (CPUs). A common form of processor is referred to as a microprocessor. CPUs use communicative signals to enable various operations. Such communicative signals may be stored and/or transmitted in batches as program and/or data components facilitate desired operations. These stored instruction code signals may engage the CPU circuit components to perform desired operations. A common type of program is a computer operating system, which, commonly, is executed by CPU on a computer; the operating system enables and facilitates users to access and operate computer information technology and resources. Common resources employed in information technology systems include: input and output mechanisms through which data may pass into and out of a computer; memory storage into which data may be saved; and processors by which information may be processed. Often information technology systems are used to collect data for later retrieval, analysis, and manipulation, commonly, which is facilitated through a database program. Information technology systems provide interfaces that allow users to access and operate various system components.

In one embodiment, the Jotamo controller 901 may be connected to and/or communicate with entities such as, but not limited to: one or more users from user input devices 911; peripheral devices 912; a cryptographic processor device 928; and/or a communications network 913.

Networks are commonly thought to comprise the interconnection and interoperation of clients, servers, and intermediary nodes in a graph topology. It should be noted that the term “server” as used throughout this disclosure refers generally to a computer, other device, program, or combination thereof that processes and responds to the requests of remote users across a communications network. Servers serve their information to requesting “clients.” The term “client” as used herein refers generally to a computer, other device, program, or combination thereof that is capable of processing and making requests and obtaining and processing any responses from servers across a communications network. A computer, other device, program, or combination thereof that facilitates, processes information and requests, and/or furthers the passage of information from a source user to a destination user is commonly referred to as a “node.” Networks are generally thought to facilitate the transfer of information from source points to destinations. A node specifically tasked with furthering the passage of information from a source to a destination is commonly called a “router.” There are many forms of networks such as Local Area Networks (LANs), Pico networks, Wide Area Networks (WANs), Wireless Networks (WLANs), etc. For example, the Internet is generally accepted as being an interconnection of a multitude of networks whereby remote clients and servers may access and interoperate with one another.

The Jotamo controller 901 may be based on common computer systems that may comprise, but are not limited to, components such as: a computer systemization 902 connected to memory 929.

Computer Systemization

A computer systemization 902 may comprise a clock 930, central processing unit (CPU) 903, a read only memory (ROM) 906, a random access memory (RAM) 905, and/or an interface bus 907, and most frequently, although not necessarily, the foregoing are all interconnected and/or communicating through a system bus 904. Optionally, the computer systemization may be connected to an internal power source 986. Optionally, a cryptographic processor 926 and/or a global positioning system (GPS) unit 975 may be connected to the system bus. The system clock typically has a crystal oscillator and provides a base signal. The clock is typically coupled to the system bus and various clock multipliers that will increase or decrease the base operating frequency for other components interconnected in the computer systemization. The clock and various components in a computer systemization drive signals embodying information throughout the system. Such transmission and reception of signals embodying information throughout a computer systemization may be commonly referred to as communications. These communicative signals may further be transmitted, received, and the cause of return and/or reply signal communications beyond the instant computer systemization to: communications networks, input devices, other computer systemizations, peripheral devices, and/or the like. Of course, any of the above components may be connected directly to one another, connected to the CPU, and/or organized in numerous variations employed as exemplified by various computer systems.

The CPU comprises at least one high-speed data processor adequate to execute program components for executing user and/or system-generated requests. The CPU may be a microprocessor such as AMD's Athlon, Duron and/or Opteron; IBM and/or Motorola's PowerPC; IBM's and Sony's Cell processor; Intel's Celeron, Itanium, Pentium, Xeon, and/or XScale; and/or the like processor(s). The CPU interacts with memory through signal passing through conductive conduits to execute stored signal program code according to conventional data processing techniques. Such signal passing facilitates communication within the Jotamo controller and beyond through various interfaces. Should processing requirements dictate a greater amount speed, parallel, mainframe and/or super-computer architectures may similarly be employed. Alternatively, should deployment requirements dictate greater portability, smaller Personal Digital Assistants (PDAs) may be employed.

Power Source

The power source 986 may be of any standard form for powering small electronic circuit board devices such as the following power cells: alkaline, lithium hydride, lithium ion, lithium polymer, nickel cadmium, solar cells, and/or the like. Other types of AC or DC power sources may be used as well. In the case of solar cells, in one embodiment, the case provides an aperture through which the solar cell may capture photonic energy. The power cell 986 is connected to at least one of the interconnected subsequent components of the Jotamo thereby providing an electric current to all subsequent components. In one example, the power source 986 is connected to the system bus component 904. In an alternative embodiment, an outside power source 986 is provided through a connection across the I/O 908 interface. For example, a USB and/or IEEE 1394 connection carries both data and power across the connection and is therefore a suitable source of power.

Interface Adapters

Interface bus(es) 907 may accept, connect, and/or communicate to a number of interface adapters, conventionally although not necessarily in the form of adapter cards, such as, but not limited to: input output interfaces (I/O) 908, storage interfaces 909, network interfaces 910, and/or the like. Optionally, cryptographic processor interfaces 927 similarly may be connected to the interface bus. The interface bus provides for the communications of interface adapters with one another as well as with other components of the computer systemization. Interface adapters are adapted for a compatible interface bus. Interface adapters conventionally connect to the interface bus via a slot architecture. Conventional slot architectures may be employed, such as, but not limited to: Accelerated Graphics Port (AGP), Card Bus, (Extended) Industry Standard Architecture ((E)ISA), Micro Channel Architecture (MCA), NuBus, Peripheral Component Interconnect (Extended) (PCI(X)), PCI Express, Personal Computer Memory Card International Association (PCMCIA), and/or the like.

Storage interfaces 909 may accept, communicate, and/or connect to a number of storage devices such as, but not limited to: storage devices 914, removable disc devices, and/or the like. Storage interfaces may employ connection protocols such as, but not limited to: (Ultra) (Serial) Advanced Technology Attachment (Packet Interface) ((Ultra) (Serial) ATA(PI)), (Enhanced) Integrated Drive Electronics ((E)IDE), Institute of Electrical and Electronics Engineers (IEEE) 1394, fiber channel, Small Computer Systems Interface (SCSI), Universal Serial Bus (USB), and/or the like.

Network interfaces 910 may accept, communicate, and/or connect to a communications network 913. Through a communications network 913, the Jotamo controller is accessible through remote clients 933b (e.g., computers with web browsers) by users 933a. Network interfaces may employ connection protocols such as, but not limited to: direct connect, Ethernet (thick, thin, twisted pair 10/100/1000 Base T, and/or the like), Token Ring, wireless connection such as IEEE 802.11a-x, and/or the like. A communications network may be any one and/or the combination of the following: a direct interconnection; the Internet; a Local Area Network (LAN); a Metropolitan Area Network (MAN); an Operating Missions as Nodes on the Internet (OMNI); a secured custom connection; a Wide Area Network (WAN); a wireless network (e.g., employing protocols such as, but not limited to a Wireless Application Protocol (WAP), I-mode, and/or the like); and/or the like. A network interface may be regarded as a specialized form of an input output interface. Further, multiple network interfaces 910 may be used to engage with various communications network types 913. For example, multiple network interfaces may be employed to allow for the communication over broadcast, multicast, and/or unicast networks.

Input Output interfaces (I/O) 908 may accept, communicate, and/or connect to user input devices 911, peripheral devices 912, cryptographic processor devices 928, and/or the like. I/O may employ connection protocols such as, but not limited to: Apple Desktop Bus (ADB); Apple Desktop Connector (ADC); audio: analog, digital, monaural, RCA, stereo, and/or the like; IEEE 1394a-b; infrared; joystick; keyboard; midi; optical; PC AT; PS/2; parallel; radio; serial; USB; video interface: BNC, coaxial, composite, digital, Digital Visual Interface (DVI), RCA, RF antennae, S-Video, VGA, and/or the like; wireless; and/or the like. A common output device is a television set, which accepts signals from a video interface. Also, a video display, which typically comprises a Cathode Ray Tube (CRT) or Liquid Crystal Display (LCD) based monitor with an interface (e.g., DVI circuitry and cable) that accepts signals from a video interface, may be used. The video interface composites information generated by a computer systemization and generates video signals based on the composited information in a video memory frame. Typically, the video interface provides the composited video information through a video connection interface that accepts a video display interface (e.g., an RCA composite video connector accepting an RCA composite video cable; a DVI connector accepting a DVI display cable, etc.).

User input devices 911 may be card readers, dongles, finger print readers, gloves, graphics tablets, joysticks, keyboards, mouse (mice), remote controls, retina readers, trackballs, trackpads, and/or the like.

Peripheral devices 912 may be connected and/or communicate to I/O and/or other facilities of the like such as network interfaces, storage interfaces, and/or the like. Peripheral devices may be audio devices, cameras, dongles (e.g., for copy protection, ensuring secure transactions with a digital signature, and/or the like), external processors (for added functionality), goggles, microphones, monitors, network interfaces, printers, scanners, storage devices, video devices, video sources, visors, and/or the like.

It should be noted that although user input devices and peripheral devices may be employed, the Jotamo controller may be embodied as an embedded, dedicated, and/or monitor-less (i.e., headless) device, wherein access would be provided over a network interface connection.

Cryptographic units such as, but not limited to, microcontrollers, processors 926, interfaces 927, and/or devices 928 may be attached, and/or communicate with the Jotamo controller. A MC68HC16 microcontroller, commonly manufactured by Motorola Inc., may be used for and/or within cryptographic units. Equivalent microcontrollers and/or processors may also be used. The MC68HC16 microcontroller utilizes a 16-bit multiply-and-accumulate instruction in the 16 MHz configuration and requires less than one second to perform a 512-bit RSA private key operation. Cryptographic units support the authentication of communications from interacting agents, as well as allow for anonymous transactions. Cryptographic units may also be configured as part of CPU. Other commercially available specialized cryptographic processors include VLSI Technology's 33 MHz 6868 or Semaphore Communications' 40 MHz Roadrunner 184.

Memory

Generally, any mechanization and/or embodiment allowing a processor to affect the storage and/or retrieval of information is regarded as memory 929. However, memory is a fungible technology and resource, thus, any number of memory embodiments may be employed in lieu of or in concert with one another. It is to be understood that the Jotamo controller and/or a computer systemization may employ various forms of memory 929. For example, a computer systemization may be configured wherein the functionality of on-chip CPU memory (e.g., registers), RAM, ROM, and any other storage devices are provided by a paper punch tape or paper punch card mechanism; of course such an embodiment would result in an extremely slow rate of operation. In a typical configuration, memory 929 will include ROM 906, RAM 905, and a storage device 914. A storage device 914 may be any conventional computer system storage. Storage devices may include a drum; a (fixed and/or removable) magnetic disk drive; a magneto-optical drive; an optical drive (i.e., CD ROM/RAM/Recordable (R), ReWritable (RW), DVD R/RW, etc.); an array of devices (e.g., Redundant Array of Independent Disks (RAID)); and/or other devices of the like. Thus, a computer systemization generally requires and makes use of memory.

Component Collection

The memory 929 may contain a collection of program and/or database components and/or data such as, but not limited to: operating system component(s) 915 (operating system); information server component(s) 916 (information server); user interface component(s) 917 (user interface); Web browser component(s) 918 (Web browser); database(s) 919; mail server component(s) 921; mail client component(s) 922; cryptographic server component(s) 920 (cryptographic server); the Jotamo component(s) 935; and/or the like (i.e., collectively a component collection). These components may be stored and accessed from the storage devices and/or from storage devices accessible through an interface bus. Although non-conventional program components such as those in the component collection, typically, are stored in a local storage device 914, they may also be loaded and/or stored in memory such as: peripheral devices, RAM, remote storage facilities through a communications network, ROM, various forms of memory, and/or the like.

Operating System

The operating system component 915 is an executable program component facilitating the operation of the Jotamo controller. Typically, the operating system facilitates access of I/O, network interfaces, peripheral devices, storage devices, and/or the like. The operating system may be a highly fault tolerant, scalable, and secure system such as Apple Macintosh OS X (Server), AT&T Plan 9, Be OS, Linux, Unix, and/or the like operating systems. However, more limited and/or less secure operating systems also may be employed such as Apple Macintosh OS, Microsoft DOS, Microsoft Windows 2000/2003/3.1/95/98/CE/Millenium/NT/Vista/XP (Server), Palm OS, and/or the like. An operating system may communicate to and/or with other components in a component collection, including itself, and/or the like. Most frequently, the operating system communicates with other program components, user interfaces, and/or the like. For example, the operating system may contain, communicate, generate, obtain, and/or provide program component, system, user, and/or data communications, requests, and/or responses. The operating system, once executed by the CPU, may enable the interaction with communications networks, data, I/O, peripheral devices, program components, memory, user input devices, and/or the like. The operating system may provide communications protocols that allow the Jotamo controller to communicate with other entities through a communications network 913. Various communication protocols may be used by the Jotamo controller as a subcarrier transport mechanism for interaction, such as, but not limited to: multicast, TCP/IP, UDP, unicast, and/or the like.

Information Server

An information server component 916 is a stored program component that is executed by a CPU. The information server may be a conventional Internet information server such as, but not limited to Apache Software Foundation's Apache, Microsoft's Internet Information Server, and/or the. The information server may allow for the execution of program components through facilities such as Active Server Page (ASP), ActiveX, (ANSI) (Objective-) C (++), C#, Common Gateway Interface (CGI) scripts, Java, JavaScript, Practical Extraction Report Language (PERL), Python, WebObjects, and/or the like. The information server may support secure communications protocols such as, but not limited to, File Transfer Protocol (FTP); HyperText Transfer Protocol (HTTP); Secure Hypertext Transfer Protocol (HTTPS), Secure Socket Layer (SSL), and/or the like. The information server provides results in the form of Web pages to Web browsers, and allows for the manipulated generation of the Web pages through interaction with other program components. After a Domain Name System (DNS) resolution portion of an HTTP request is resolved to a particular information server, the information server resolves requests for information at specified locations on the Jotamo controller based on the remainder of the HTTP request. For example, a request such as http://123.124.125.126/myInformation.html might have the IP portion of the request “123.124.125.126” resolved by a DNS server to an information server at that IP address; that information server might in turn further parse the http request for the “/myInformation.html” portion of the request and resolve it to a location in memory containing the information “myInformation.html.” Additionally, other information serving protocols may be employed across various ports, e.g., FTP communications across port 21, and/or the like. An information server may communicate to and/or with other components in a component collection, including itself, and/or facilities of the like. Most frequently, the information server communicates with the Jotamo database 919, operating systems, other program components, user interfaces, Web browsers, and/or the like.

Access to the Jotamo database may be achieved through a number of database bridge mechanisms such as through scripting languages as enumerated below (e.g., CGI) and through inter-application communication channels as enumerated below (e.g., CORBA, WebObjects, etc.). Any data requests through a Web browser are parsed through the bridge mechanism into appropriate grammars as required by the Jotamo. In one embodiment, the information server would provide a Web form accessible by a Web browser. Entries made into supplied fields in the Web form are tagged as having been entered into the particular fields, and parsed as such. The entered terms are then passed along with the field tags, which act to instruct the parser to generate queries directed to appropriate tables and/or fields. In one embodiment, the parser may generate queries in standard SQL by instantiating a search string with the proper join/select commands based on the tagged text entries, wherein the resulting command is provided over the bridge mechanism to the Jotamo as a query. Upon generating query results from the query, the results are passed over the bridge mechanism, and may be parsed for formatting and generation of a new results Web page by the bridge mechanism. Such a new results Web page is then provided to the information server, which may supply it to the requesting Web browser.

Also, an information server may contain, communicate, generate, obtain, and/or provide program component, system, user, and/or data communications, requests, and/or responses.

User Interface

The function of computer interfaces in some respects is similar to automobile operation interfaces. Automobile operation interface elements such as steering wheels, gearshifts, and speedometers facilitate the access, operation, and display of automobile resources, functionality, and status. Computer interaction interface elements such as check boxes, cursors, menus, scrollers, and windows (collectively and commonly referred to as widgets) similarly facilitate the access, operation, and display of data and computer hardware and operating system resources, functionality, and status. Operation interfaces are commonly called user interfaces. Graphical user interfaces (GUIs) such as the Apple Macintosh Operating System's Aqua, Microsoft's Windows XP, or Unix's X-Windows provide a baseline and means of accessing and displaying information graphically to users.

A user interface component 917 is a stored program component that is executed by a CPU. The user interface may be a conventional graphic user interface as provided by, with, and/or atop operating systems and/or operating environments such as Apple Macintosh OS, e.g., Aqua, GNUSTEP, Microsoft Windows (NT/XP), Unix X Windows (KDE, Gnome, and/or the like), mythTV, and/or the like. The user interface may allow for the display, execution, interaction, manipulation, and/or operation of program components and/or system facilities through textual and/or graphical facilities. The user interface provides a facility through which users may affect, interact with, and/or operate a computer system. A user interface may communicate to and/or with other components in a component collection, including itself, and/or facilities of the like. Most frequently, the user interface communicates with operating systems, other program components, and/or the like. The user interface may contain, communicate, generate, obtain, and/or provide program component, system, user, and/or data communications, requests, and/or responses.

Web Browser

A Web browser component 918 is a stored program component that is executed by a CPU. The Web browser may be a conventional hypertext viewing application such as Microsoft Internet Explorer or Netscape Navigator. Secure Web browsing may be supplied with 128 bit (or greater) encryption by way of HTTPS, SSL, and/or the like. Some Web browsers allow for the execution of program components through facilities such as Java, JavaScript, ActiveX, and/or the like. Web browsers and like information access tools may be integrated into PDAs, cellular telephones, and/or other mobile devices. A Web browser may communicate to and/or with other components in a component collection, including itself, and/or facilities of the like. Most frequently, the Web browser communicates with information servers, operating systems, integrated program components (e.g., plug-ins), and/or the like; e.g., it may contain, communicate, generate, obtain, and/or provide program component, system, user, and/or data communications, requests, and/or responses. Of course, in place of a Web browser and information server, a combined application may be developed to perform similar functions of both. The combined application would similarly affect the obtaining and the provision of information to users, user agents, and/or the like from the Jotamo enabled nodes. The combined application may be nugatory on systems employing standard Web browsers.

Mail Server

A mail server component 921 is a stored program component that is executed by a CPU 903. The mail server may be a conventional Internet mail server such as, but not limited to sendmail, Microsoft Exchange, and/or the. The mail server may allow for the execution of program components through facilities such as ASP, ActiveX, (ANSI) (Objective-) C (++), CGI scripts, Java, JavaScript, PERL, pipes, Python, WebObjects, and/or the like. The mail server may support communications protocols such as, but not limited to: Internet message access protocol (IMAP), Microsoft Exchange, post office protocol (POPS), simple mail transfer protocol (SMTP), and/or the like. The mail server can route, forward, and process incoming and outgoing mail messages that have been sent, relayed and/or otherwise traversing through and/or to the Jotamo.

Access to the Jotamo mail may be achieved through a number of APIs offered by the individual Web server components and/or the operating system.

Also, a mail server may contain, communicate, generate, obtain, and/or provide program component, system, user, and/or data communications, requests, information, and/or responses.

Mail Client

A mail client component 922 is a stored program component that is executed by a CPU 903. The mail client may be a conventional mail viewing application such as Apple Mail, Microsoft Entourage, Microsoft Outlook, Microsoft Outlook Express, Mozilla Thunderbird, and/or the like. Mail clients may support a number of transfer protocols, such as: IMAP, Microsoft Exchange, POP3, SMTP, and/or the like. A mail client may communicate to and/or with other components in a component collection, including itself, and/or facilities of the like. Most frequently, the mail client communicates with mail servers, operating systems, other mail clients, and/or the like; e.g., it may contain, communicate, generate, obtain, and/or provide program component, system, user, and/or data communications, requests, information, and/or responses. Generally, the mail client provides a facility to compose and transmit electronic mail messages.

Cryptographic Server

A cryptographic server component 920 is a stored program component that is executed by a CPU 903, cryptographic processor 926, cryptographic processor interface 927, cryptographic processor device 928, and/or the like. Cryptographic processor interfaces will allow for expedition of encryption and/or decryption requests by the cryptographic component; however, the cryptographic component, alternatively, may run on a conventional CPU. The cryptographic component allows for the encryption and/or decryption of provided data. The cryptographic component allows for both symmetric and asymmetric (e.g., Pretty Good Protection (PGP)) encryption and/or decryption. The cryptographic component may employ cryptographic techniques such as, but not limited to: digital certificates (e.g., X.509 authentication framework), digital signatures, dual signatures, enveloping, password access protection, public key management, and/or the like. The cryptographic component will facilitate numerous (encryption and/or decryption) security protocols such as, but not limited to: checksum, Data Encryption Standard (DES), Elliptical Curve Encryption (ECC), International Data Encryption Algorithm (IDEA), Message Digest 5 (MD5, which is a one way hash function), passwords, Rivest Cipher (RC5), Rijndael, RSA (which is an Internet encryption and authentication system that uses an algorithm developed in 1977 by Ron Rivest, Adi Shamir, and Leonard Adleman), Secure Hash Algorithm (SHA), Secure Socket Layer (SSL), Secure Hypertext Transfer Protocol (HTTPS), and/or the like. Employing such encryption security protocols, the Jotamo may encrypt all incoming and/or outgoing communications and may serve as node within a virtual private network (VPN) with a wider communications network. The cryptographic component facilitates the process of “security authorization” whereby access to a resource is inhibited by a security protocol wherein the cryptographic component effects authorized access to the secured resource. In addition, the cryptographic component may provide unique identifiers of content, e.g., employing and MD5 hash to obtain a unique signature for an digital audio file. A cryptographic component may communicate to and/or with other components in a component collection, including itself, and/or facilities of the like. The cryptographic component supports encryption schemes allowing for the secure transmission of information across a communications network to enable the Jotamo component to engage in secure transactions if so desired. The cryptographic component facilitates the secure accessing of resources on the Jotamo and facilitates the access of secured resources on remote systems; i.e., it may act as a client and/or server of secured resources. Most frequently, the cryptographic component communicates with information servers, operating systems, other program components, and/or the like. The cryptographic component may contain, communicate, generate, obtain, and/or provide program component, system, user, and/or data communications, requests, and/or responses.

The Jotamo Database

The Jotamo database component 919 may be embodied in a database and its stored data. The database is a stored program component, which is executed by the CPU; the stored program component portion configuring the CPU to process the stored data. The database may be a conventional, fault tolerant, relational, scalable, secure database such as Oracle or Sybase. Relational databases are an extension of a flat file. Relational databases consist of a series of related tables. The tables are interconnected via a key field. Use of the key field allows the combination of the tables by indexing against the key field; i.e., the key fields act as dimensional pivot points for combining information from various tables. Relationships generally identify links maintained between tables by matching primary keys. Primary keys represent fields that uniquely identify the rows of a table in a relational database. More precisely, they uniquely identify rows of a table on the “one” side of a one-to-many relationship.

Alternatively, the Jotamo database may be implemented using various standard data-structures, such as an array, hash, (linked) list, struct, structured text file (e.g., XML), table, and/or the like. Such data-structures may be stored in memory and/or in (structured) files. In another alternative, an object-oriented database may be used, such as Frontier, ObjectStore, Poet, Zope, and/or the like. Object databases can include a number of object collections that are grouped and/or linked together by common attributes; they may be related to other object collections by some common attributes. Object-oriented databases perform similarly to relational databases with the exception that objects are not just pieces of data but may have other types of functionality encapsulated within a given object. If the Jotamo database is implemented as a data-structure, the use of the Jotamo database 919 may be integrated into another component such as the Jotamo component 935. Also, the database may be implemented as a mix of data structures, objects, and relational structures. Databases may be consolidated and/or distributed in countless variations through standard data processing techniques. Portions of databases, e.g., tables, may be exported and/or imported and thus decentralized and/or integrated.

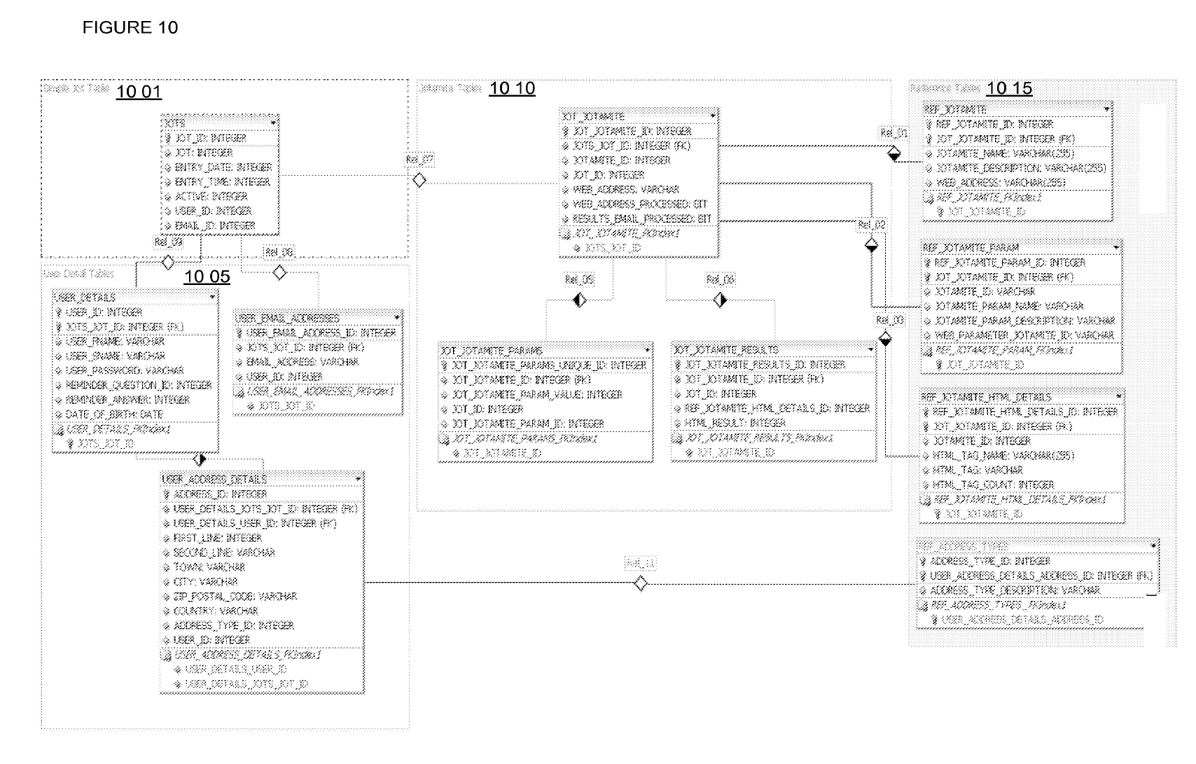

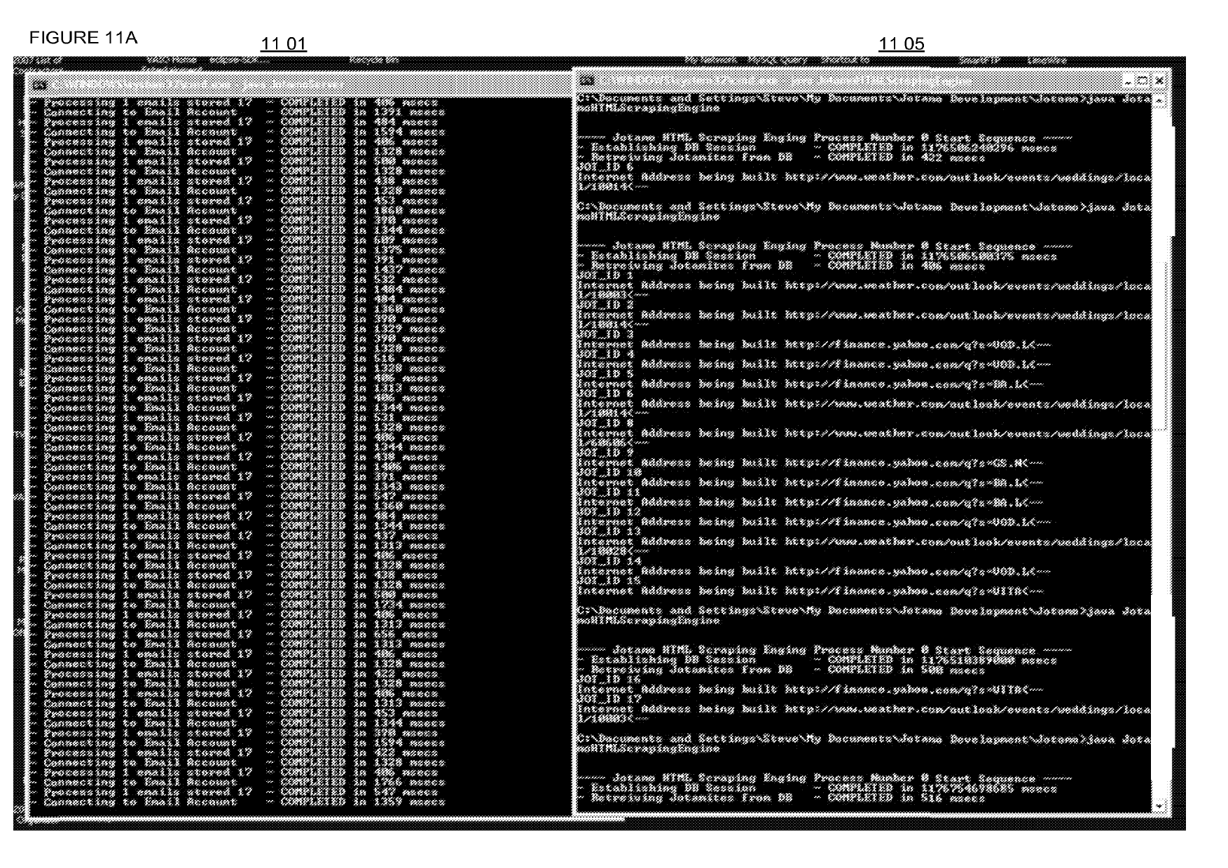

In one embodiment, the database component 919 includes several tables 919a-g. A Users table 919a may include fields such as, but not limited to: user_ID (key field), user name, contact info, user profile, user group affiliation, user input device(s), user display device(s), user Jots/Jotamites, custom data sources, personal and/or group data stores, and/or the like. A User Details table 919b may include fields such as, but not limited to: user_ID (key field), jots_jot_ID (key field), user frame, user_sname, user_password, reminder_question_ID, reminder_answer, date_of_birth, and/or the like. A User Email Addresses table 919c may include fields such as, but not limited to: user_email_address_ID (key field), jots_jot_ID, email_address, user_ID, and/or the like. A User Address Details table 919d may include fields such as, but not limited to: address_ID (key field), user_details_jots_jot_ID, user_details_user_ID, first_line, second_line, town, city, zip_postal_code, country, address, user_ID, and/or the like. A Partners table 919e may include fields such as, but not limited to: partner ID, partner name, partner contact info, partner category, associated Jotamites, data request requirements, logins, passwords, partnership terms, and/or the like. A Jotatmite/Query Templates table 919f may include fields such as, but not limited to: template ID, template type, template fields, associated partner(s) and/or data sources, associated input and/or output device(s), and/or the like. A Contexts table 919g may include fields such as, but not limited to: context ID, context name, context parameters, associated users, associated partners, and/or the like. A SimpleJot table 919h may include fields such as, but not limited to: jot_ID, jot, entry_date, entry_time, active, user_ID, email_ID, and/or the like. A Jotamite table 919i may include fields such as, but not limited to: Jotamite ID, web address, processing status, Jotamite parameters, Jotamite results, user ID, email ID, and/or the like. A Jot Jotamite table 919j may include fields such as, but not limited to: jot_jotamite_ID (key field), jots_jot_ID, jotamite_ID, jot_ID, web_address, web_address_processed, results_email_processed, and/or the like. A Jot Jotamite Params table 919k may include fields such as, but not limited to: jot_jotamite_params_unique_ID (key field), jot_jotamite_ID, jot_jotamite_param_value, jot_ID, jot_jotamite_param_ID, and/or the like. A Jot Jotamite Results table 919l may include fields such as, but not limited to: jot jot_jotamite_results_ID (key field), jot_jotamite_ID, jot_ID, ref_jotamite_html_details_ID, html_result, and/or the like. A Reference table 919m may include fields such as, but not limited to: reference Jotamite Id, Jotamite name, Jotamite ID, Jotamite description, web address, reference Jotamite parameter, Jotamite parameter name, Jotamite parameter description, reference Jotamite HTML details, HTML tag name, reference address type, address type ID, user address details, and/or the like. A Ref_Jotamite table 919n may include fields such as, but not limited to: ref jotamite_ID (key field), jot_jotamite_ID (key field), jotamite_name, jotamite_description, web_address, and/or the like. A Ref Jotamite Param table 919o may include fields such as, but not limited to: ref_jotamite_param_ID (key field), jot_jotamite_ID (key field), jotamite_ID, jotamite_param_name, jotamite_param_description, web_parameter_jotamite_ID, and/or the like. A Ref Jotamite HTML Details table 919p may include fields such as, but not limited to: ref_jotamite_html_details_ID (key field), jot_jotamite_ID (key field), jotamite_ID, html_tag_name, html_tag, html_tag_count, and/or the like. A Ref Address Types table 919q may include fields such as, but not limited to: address_type_ID (key field), user_address_details_address_ID (key field), address_type_description, and/or the like. FIG. 10 shows further details surrounding table fields and associations in one embodiment, including a simple jot table 1001, user detail tables 1005, jotamite tables 1010, and reference tables 1015. These and/or other tables may support and/or track multiple entity accounts on the Platform.

In one embodiment, the Jotamo database may interact with other database systems. For example, employing a distributed database system, queries and data access by Jotamo modules may treat the combination of the Jotamo database and another database as a single database entity.

In one embodiment, user programs may contain various user interface primitives, which may serve to update the Jotamo. Also, various accounts may require custom database tables depending upon the environments and the types of clients the Jotamo may need to serve. It should be noted that any unique fields may be designated as a key field throughout. In an alternative embodiment, these tables have been decentralized into their own databases and their respective database controllers (i.e., individual database controllers for each of the above tables). Employing standard data processing techniques, one may further distribute the databases over several computer systemizations and/or storage devices. Similarly, configurations of the decentralized database controllers may be varied by consolidating and/or distributing the various database components 919a-g. The Jotamo may be configured to keep track of various settings, inputs, and parameters via database controllers.

The Jotamo database may communicate to and/or with other components in a component collection, including itself, and/or facilities of the like. Most frequently, the Jotamo database communicates with the Jotamo component, other program components, and/or the like. The database may contain, retain, and provide information regarding other nodes and data.

The Jotamo Component

The Jotamo component 935 is a stored program component that is executed by a CPU. The Jotamo component affects accessing, obtaining and the provision of information, services, transactions, and/or the like across various communications networks. As such, the Jotamo component enables one to access, calculate, engage, exchange, generate, identify, instruct, match, process, search, serve, store, and/or facilitate transactions to enable multi-modal data interfacing. In one embodiment, the Jotamo component incorporates any and/or all combinations of the aspects of the Jatomo that were discussed in the previous figures and appendices.

The Jotamo component enabling access of information between nodes may be developed by employing standard development tools such as, but not limited to: (ANSI) (Objective-) C (-HO, Apache components, binary executables, database adapters, Java, JavaScript, mapping tools, procedural and object oriented development tools, PERL, Python, shell scripts, SQL commands, web application server extensions, WebObjects, and/or the like. In one embodiment, the Jotamo server employs a cryptographic server to encrypt and decrypt communications. The Jotamo component may communicate to and/or with other components in a component collection, including itself, and/or facilities of the like. Most frequently, the Jotamo component communicates with the Jotamo database, operating systems, other program components, and/or the like. The Jotamo may contain, communicate, generate, obtain, and/or provide program component, system, user, and/or data communications, requests, and/or responses.

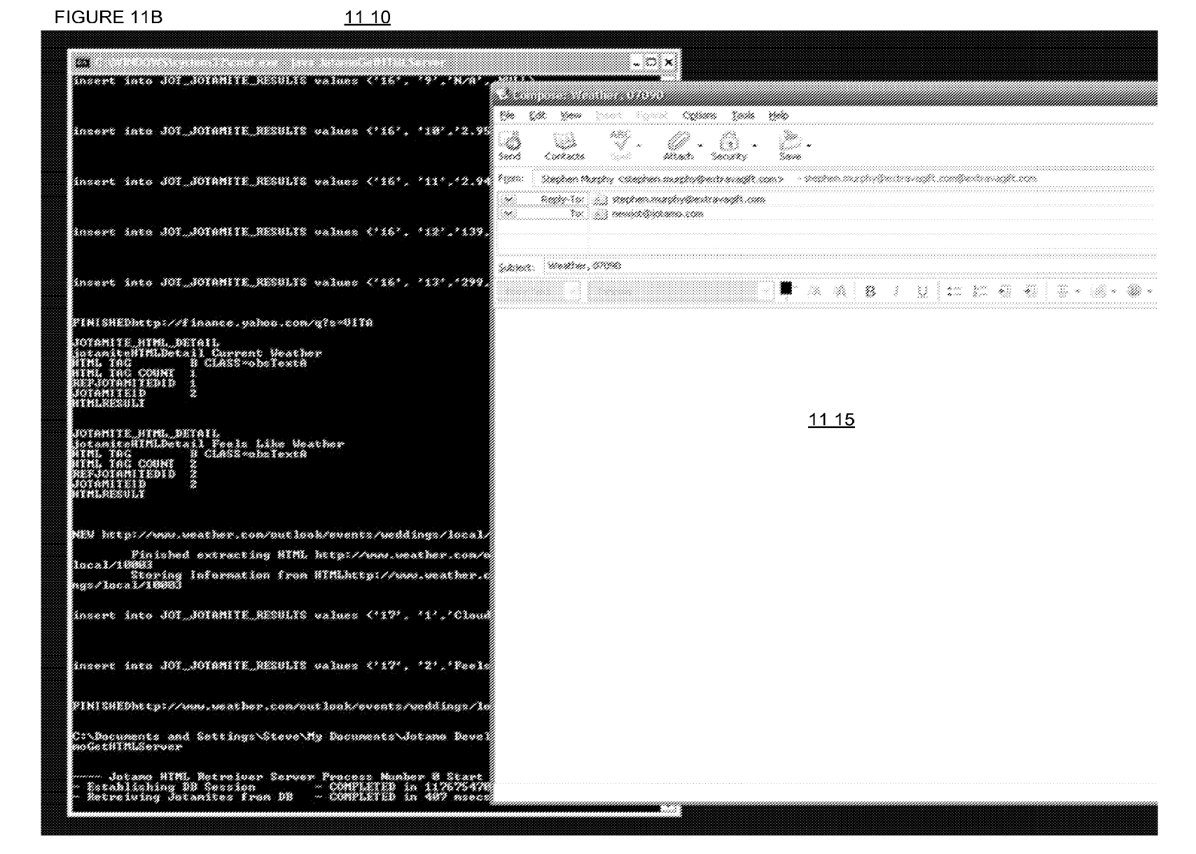

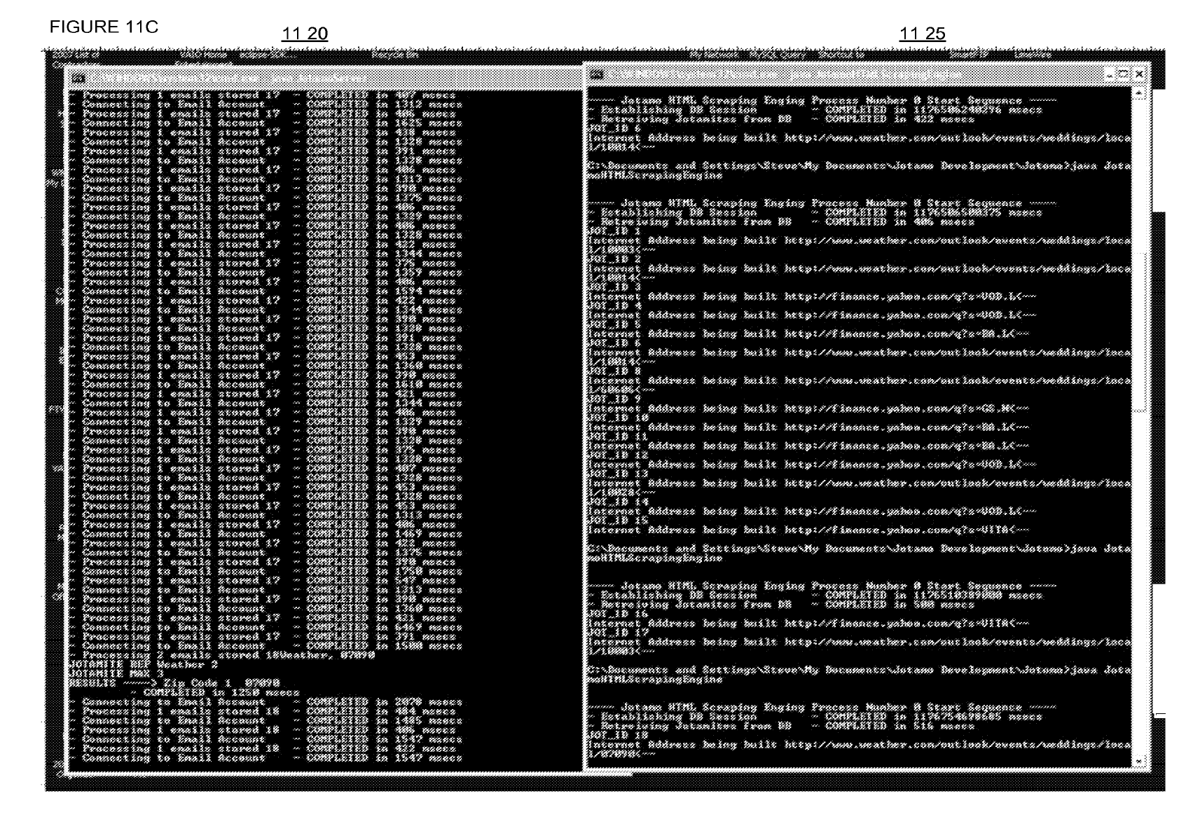

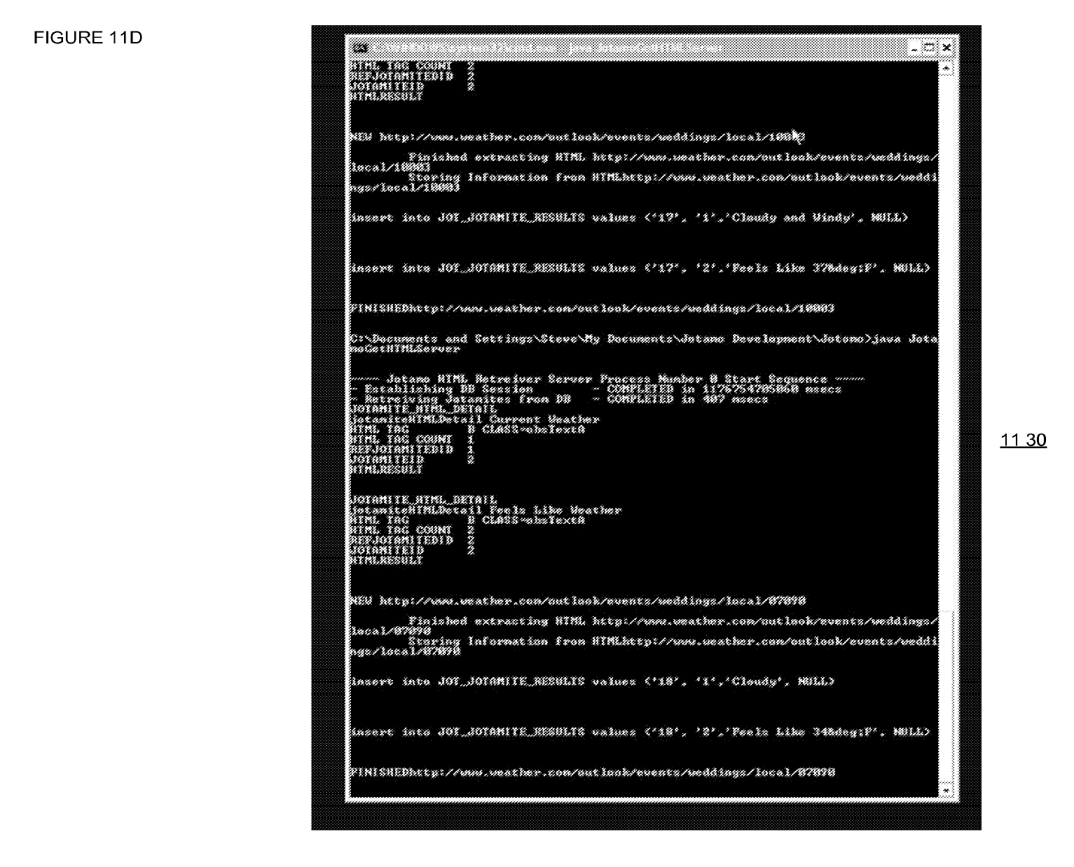

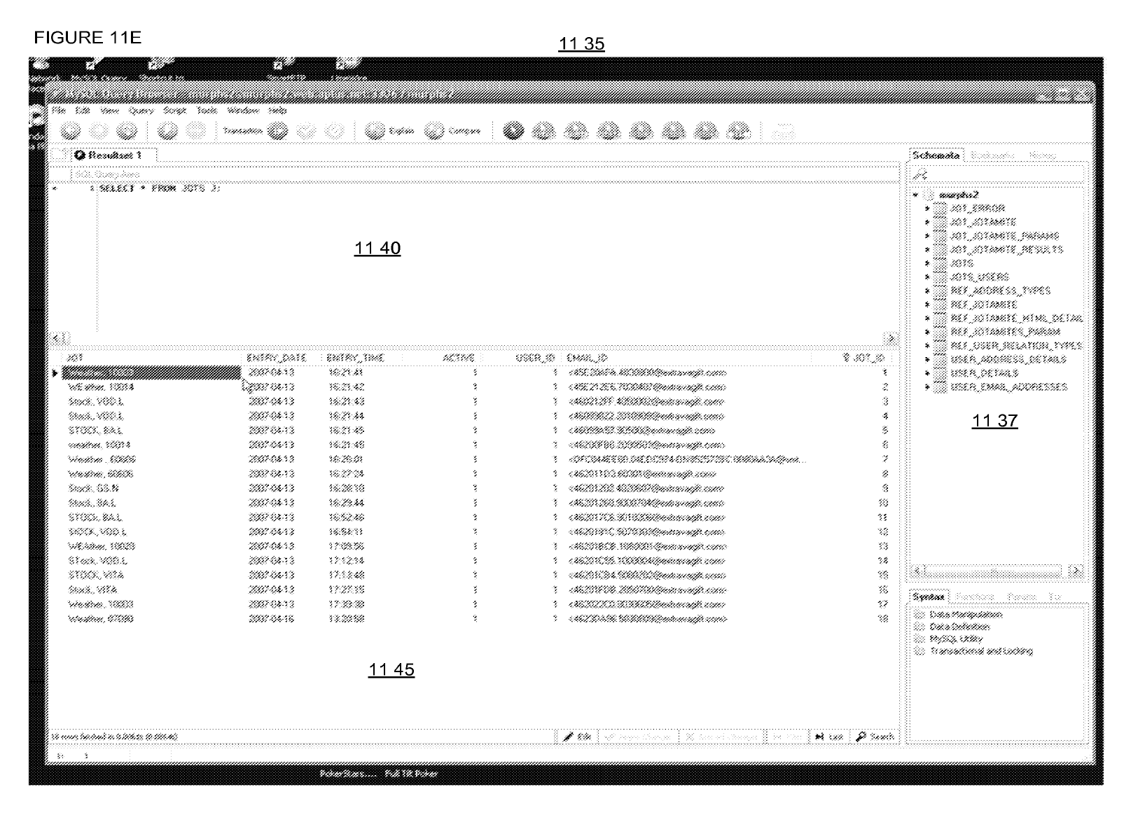

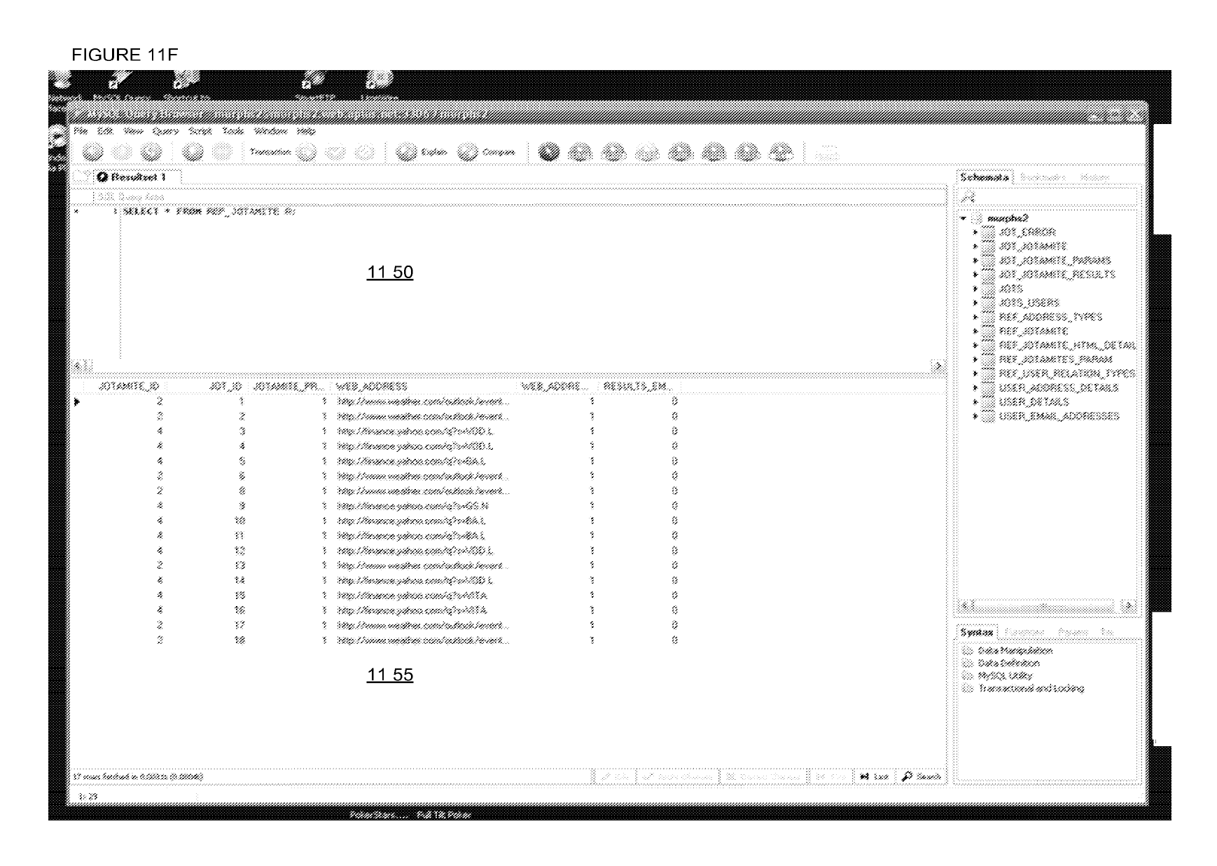

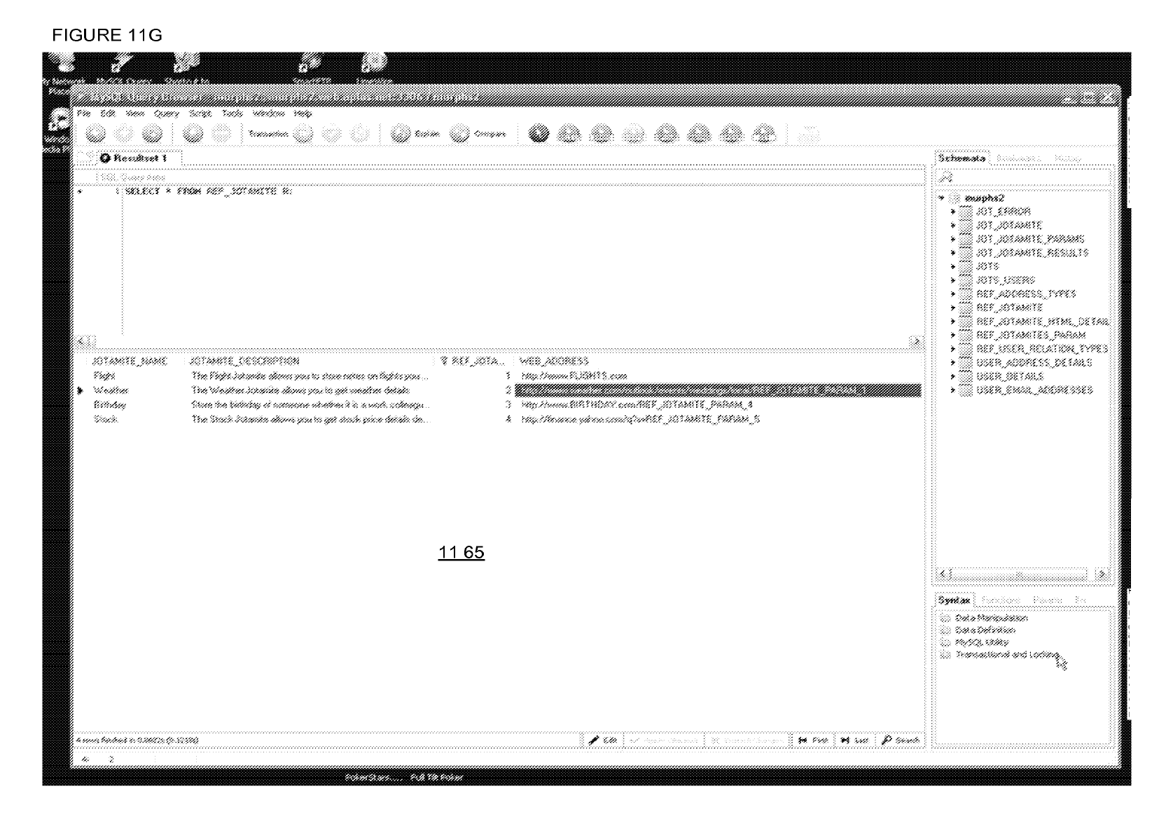

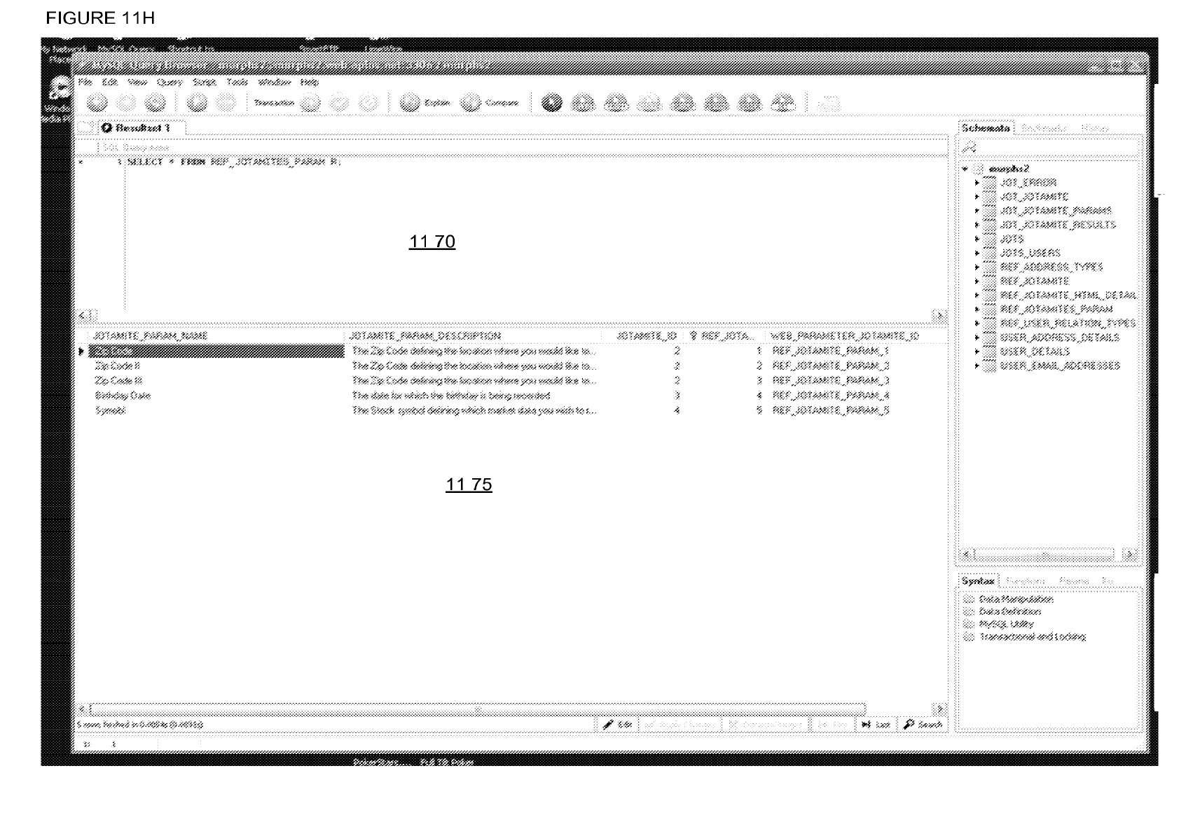

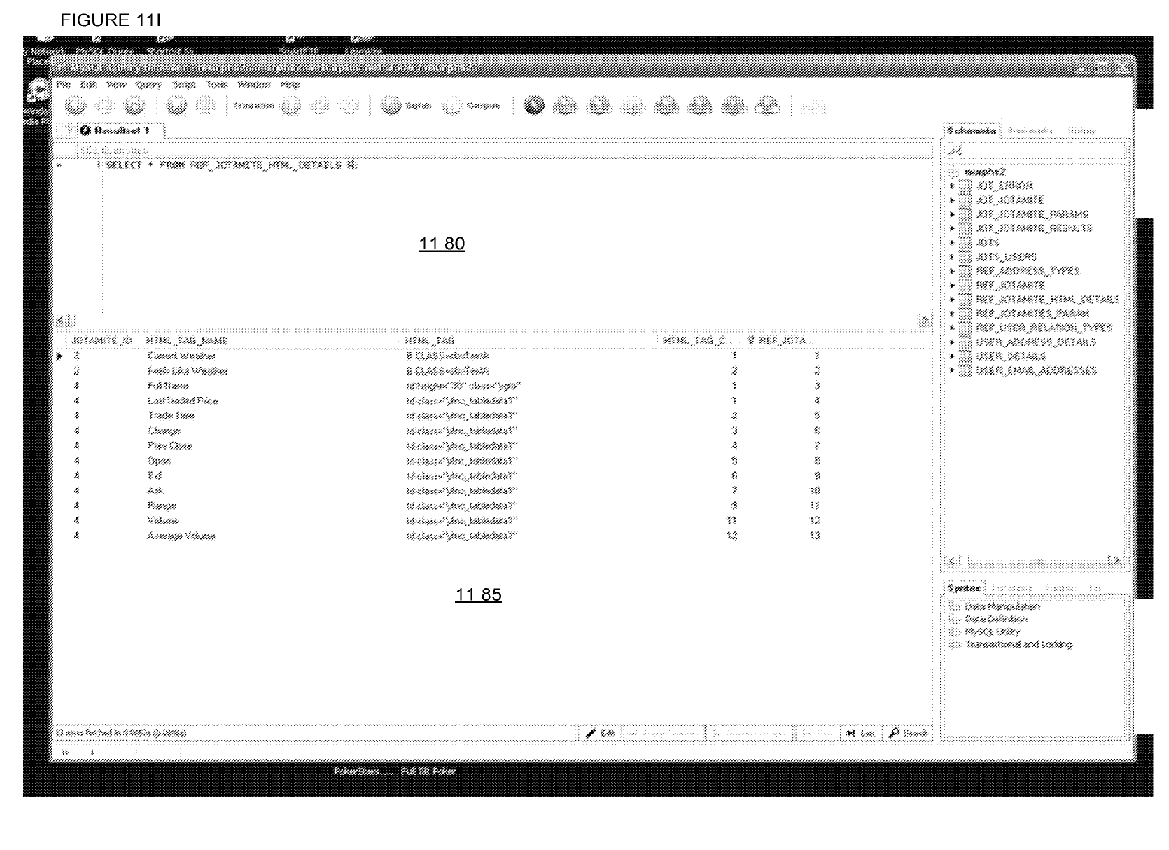

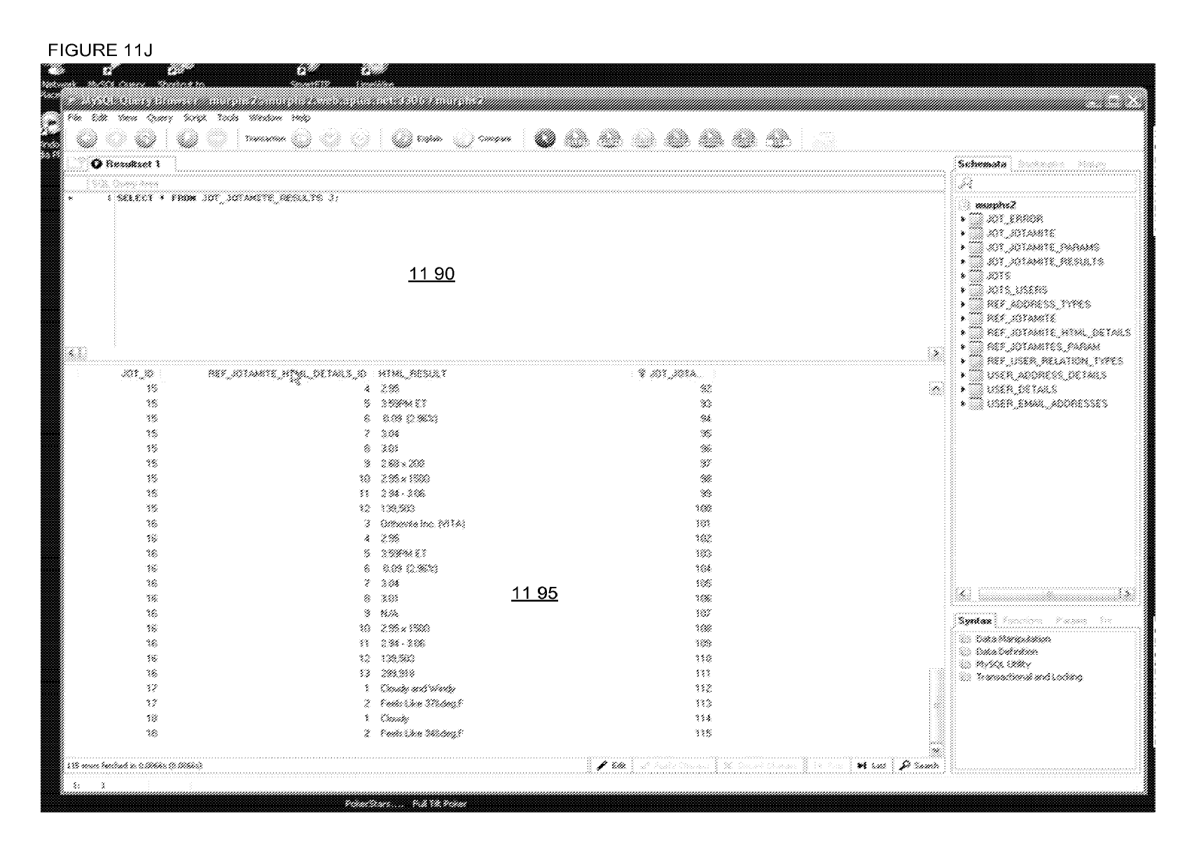

FIGS. 11A-J show implementations of some Jotamo component interactions with one or more Jotamo databases and/or database tables in one embodiment of Jotamo operation. FIG. 11A shows aspects of request/response transactions 1101 and Jotamo HTML scraping engine operation 1105. FIG. 11B shows Jotamo Get HTML server operation 1110 and a window for composing an email to the Jotamo system to submit a query request (“weather, 07090”) 1115. FIG. 11C shows Jotamo operations in response to the query request 1115, including request/response transactions 1120 and Jotamo HTML scraping engine operation 1125. FIG. 11D shows Jotamo Get HTML server operation 1130 in response to the query request 1115. FIG. 11E shows a MySQL query browser window 1135 including a list of data tables referenced 1137, a query area in which a “Jots” query is entered 1140, and a listing of Jots records 1145. In FIG. 11F, the query window entry is changed to “Ref_Jotamite” 1150, and a listing of Ref_Jotamite records arranged by Jot_ID is shown 1155. In FIG. 11G, an alternative listing of Ref_Jotamite records is shown organized by Jotamite Name 1165. In FIG. 11H, the query window entry is changed to “Ref_Jotamites_Param” 1170, and a listing of Ref_Jotamites_Param records is shown 1175. In FIG. 11I, the query window entry is changed to “Ref_Jotamite_HTML_Details” 1180, and a listing of Ref_Jotamite_HTML_Details records is shown 1185. In FIG. 11J, the query window entry is changed to “Jot_Jotamite_Results” 1190, and a listing of Jot Jotamite Results records is shown 1195.

Distributed Jotamo

The structure and/or operation of any of the Jotamo node controller components may be combined, consolidated, and/or distributed in any number of ways to facilitate development and/or deployment. Similarly, the component collection may be combined in any number of ways to facilitate deployment and/or development. To accomplish this, one may integrate the components into a common code base or in a facility that can dynamically load the components on demand in an integrated fashion.

The component collection may be consolidated and/or distributed in countless variations through standard data processing and/or development techniques. Multiple instances of any one of the program components in the program component collection may be instantiated on a single node, and/or across numerous nodes to improve performance through load-balancing and/or data-processing techniques. Furthermore, single instances may also be distributed across multiple controllers and/or storage devices; e.g., databases. All program component instances and controllers working in concert may do so through standard data processing communication techniques.

The configuration of the Jotamo controller will depend on the context of system deployment. Factors such as, but not limited to, the budget, capacity, location, and/or use of the underlying hardware resources may affect deployment requirements and configuration. Regardless of if the configuration results in more consolidated and/or integrated program components, results in a more distributed series of program components, and/or results in some combination between a consolidated and distributed configuration, data may be communicated, obtained, and/or provided. Instances of components consolidated into a common code base from the program component collection may communicate, obtain, and/or provide data. This may be accomplished through intra-application data processing communication techniques such as, but not limited to: data referencing (e.g., pointers), internal messaging, object instance variable communication, shared memory space, variable passing, and/or the like.

If component collection components are discrete, separate, and/or external to one another, then communicating, obtaining, and/or providing data with and/or to other component components may be accomplished through inter-application data processing communication techniques such as, but not limited to: Application Program Interfaces (API) information passage; (distributed) Component Object Model ((D)COM), (Distributed) Object Linking and Embedding ((D)OLE), and/or the like), Common Object Request Broker Architecture (CORBA), process pipes, shared files, and/or the like. Messages sent between discrete component components for inter-application communication or within memory spaces of a singular component for intra-application communication may be facilitated through the creation and parsing of a grammar. A grammar may be developed by using standard development tools such as lex, yacc, XML, and/or the like, which allow for grammar generation and parsing functionality, which in turn may form the basis of communication messages within and between components. Again, the configuration will depend upon the context of system deployment.

The entirety of this disclosure (including the Cover Page, Title, Headings, Field, Background, Summary, Brief Description of the Drawings, Detailed Description, Claims, Abstract, Figures, and otherwise) shows by way of illustration various embodiments in which the claimed inventions may be practiced. The advantages and features of the disclosure are of a representative sample of embodiments only, and are not exhaustive and/or exclusive. They are presented only to assist in understanding and teach the claimed principles. It should be understood that they are not representative of all claimed inventions. As such, certain aspects of the disclosure have not been discussed herein. That alternate embodiments may not have been presented for a specific portion of the invention or that further undescribed alternate embodiments may be available for a portion is not to be considered a disclaimer of those alternate embodiments. It will be appreciated that many of those undescribed embodiments incorporate the same principles of the invention and others are equivalent. Thus, it is to be understood that other embodiments may be utilized and functional, logical, organizational, structural and/or topological modifications may be made without departing from the scope and/or spirit of the disclosure. As such, all examples and/or embodiments are deemed to be non-limiting throughout this disclosure. Also, no inference should be drawn regarding those embodiments discussed herein relative to those not discussed herein other than it is as such for purposes of reducing space and repetition. For instance, it is to be understood that the logical and/or topological structure of any combination of any program components (a component collection), other components and/or any present feature sets as described in the figures and/or throughout are not limited to a fixed operating order and/or arrangement, but rather, any disclosed order is exemplary and all equivalents, regardless of order, are contemplated by the disclosure. Furthermore, it is to be understood that such features are not limited to serial execution, but rather, any number of threads, processes, services, servers, and/or the like that may execute asynchronously, concurrently, in parallel, simultaneously, synchronously, and/or the like are contemplated by the disclosure. As such, some of these features may be mutually contradictory, in that they cannot be simultaneously present in a single embodiment. Similarly, some features are applicable to one aspect of the invention, and inapplicable to others. In addition, the disclosure includes other inventions not presently claimed. Applicant reserves all rights in those presently unclaimed inventions including the right to claim such inventions, file additional applications, continuations, continuations in part, divisions, and/or the like thereof. As such, it should be understood that advantages, embodiments, examples, functional, features, logical, organizational, structural, topological, and/or other aspects of the disclosure are not to be considered limitations on the disclosure as defined by the claims or limitations on equivalents to the claims.

What is claimed is:

1. A processor-implemented method for responding to user text string queries, comprising:
receiving a user input information, the user input information including at least a user identification information and a user text string;
parsing the user text string into a plurality of tokens;
analyzing the plurality of tokens to determine a user text string classification, the analysis capable of identifying at least one user text string classification identifier token among the plurality of tokens when such an at least one user text string classification identifier token is present, and of otherwise classifying the user text string based on an identification of token types of the plurality of tokens; and
performing a response action based on the user text string classification and at least one token of the plurality of tokens, the response action including at least storing the at least one token of the plurality of tokens in a user database.

2. The method of claim 1, wherein the user input information is sent from a mobile device.

3. The method of claim 1, wherein the parsing the user text string into a plurality of tokens is based on the presence of token separation characters.

4. The method of claim 1, wherein the classifying the user text string based on an identification of token types of the plurality of tokens comprises:
identifying a token type for each token of the plurality of tokens based on token character attributes;
comparing token types of the plurality of tokens to expected token types for each user text string classification to determine a number of matches; and
setting a user text string classification for the user text string based on the number of matches.

5. The method of claim 4, wherein the token character attributes comprise a number of token characters.

6. The method of claim 4, wherein the token character attributes comprise an order of token characters.

7. The method of claim 4, wherein the token character attributes comprise a presence of a character sequence in the token.

8. The method of claim 4, wherein setting the user text string classification for the user text string based on the number of matches comprises selecting a user text string classification having a largest number of matches.

9. The method of claim 8, wherein the setting the user text string classification for the user text string based on the number of matches further comprises selecting a user text string classification based on historical user text string classifications when more than one user text string classification have the largest number of matches.

10. The method of claim 9, wherein the historical user text string classifications correspond to a single user.

11. The method of claim 9, wherein the historical user text string classifications correspond to a plurality of users.

12. The method of claim 1, further comprising:
including a user confirmation request when the user text string classification is based on an identification of token types of the plurality of tokens;
receiving a user confirmation in response to the user confirmation request; and
providing a list of selectable user text string classification candidates.

13. The method of claim 12, further comprising:
providing a user text string classification manual entry option.

14. The method of claim 1, wherein the user text string comprises an unstructured request to store information and requires no reply.

15. The method of claim 1, wherein the user query text comprises a structured request to store information and requires no reply.

16. The method of claim 1, wherein the user text string comprises a request for a reply.

17. The method of claim 1, wherein the response action further comprises:
selecting a data repository based on the at least one user text string classification;
generating a requested data lookup query based on at least one user query token and the at least one user text string classification;
submitting the requested data lookup query to the data repository; and
receiving a requested data output from the data repository based on the submitted requested data lookup query.

18. The method of claim 17, wherein the user input information is sent from a mobile device.

19. The method of claim 17, wherein the parsing the user text string into a plurality of tokens is based on the presence of token separation characters.

20. The method of claim 17, wherein the classifying the user text string based on an identification of token types of the plurality of tokens comprises:
identifying a token type for each token of the plurality of tokens based on token character attributes;
comparing token types of the plurality of tokens to expected token types for each user text string classification to determine a number of matches; and
setting a user text string classification for the user text string based on the number of matches.

21. The method of claim 20, wherein the token character attributes comprise a number of token characters.

22. The method of claim 20, wherein the token character attributes comprise an order of token characters.

23. The method of claim 20, wherein the token character attributes comprise a presence of a character sequence in the token.

24. The method of claim 20, wherein setting the user text string classification for the user text string based on the number of matches comprises selecting a user text string classification having a largest number of matches.

25. The method of claim 24, wherein the setting the user text string classification for the user text string based on the number of matches further comprises selecting a user text string classification based on historical user text string classifications when more than one user text string classification have the largest number of matches.

26. The method of claim 25, wherein the historical user text string classifications correspond to a single user.

27. The method of claim 25, wherein the historical user text string classifications correspond to a plurality of users.

28. The method of claim 17, further comprising:
including a user confirmation request when the user text string classification is based on an identification of token types of the plurality of tokens;
receiving a user confirmation in response to the user confirmation request; and
providing a list of selectable user text string classification candidates.

29. The method of claim 28, further comprising:
providing a user text string classification manual entry option.

30. The method of claim 17, wherein the user text string comprises an unstructured request to store information and requires no reply.

31. The method of claim 17, wherein the user query text comprises a structured request to store information and requires no reply.

32. The method of claim 17, wherein the user text string comprises a request for a reply.

33. The method of claim 17, wherein the requested data lookup query is further based on the user identification information.

34. The method of claim 33, wherein the user input information further includes a password, and the requested data lookup query is further based on the password.

35. The method of claim 17, wherein the data repository comprises a database.

36. The method of claim 35, wherein the database is a corporate database.

37. The method of claim 17, wherein the data repository comprises a web server.

38. The method of claim 17, further comprising:
packaging the requested data output; and
sending the requested data output to a user display device.

39. The method of claim 38, further comprising:
querying a user profile based on the user identification information; and
configuring the packaging the requested data output based at least in part on an instruction contained in the user profile.

40. The method of claim 38, wherein the user input information is received from a user input device.

41. The method of claim 40, wherein the user input device is the same as the user display device.

42. The method of claim 41, wherein the user input information further comprises a user input device identification information.

43. The method of claim 42, wherein the packaging the requested data output is based at least in part on the user input device identification information.

44. The method of claim 41, wherein the user input information takes the form of a text message.

45. The method of claim 41, wherein the user input information takes the form of an email.

46. The method of claim 41, wherein the user input information takes the form of an instant message.

47. The method of claim 41, wherein the user input information takes the form of a voice message.

48. An apparatus for responding to user text string queries, comprising:
a memory;
a processor disposed in communication with said memory, and configured to issue a plurality of processing instructions stored in the memory, wherein the instructions comprise:
receive a user input information, the user input information including at least a user identification information and a user text string;
parse the user text string into a plurality of tokens;
analyze the plurality of tokens to determine a user text string classification, the analysis capable of identifying at least one user text string classification identifier token among the plurality of tokens when such an at least one user text string classification identifier token is present, and of otherwise classifying the user text string based on an identification of token types of the plurality of tokens; and
perform a response action based on the user text string classification and at least one token of the plurality of tokens, the response action including at least storing the at least one token of the plurality of tokens in a user database.

49. A processor-accessible medium for responding to user text string queries, comprising:
processor readable instructions stored in the processor-accessible medium, wherein the processor readable instructions are issuable by a processor to:
receive a user input information, the user input information including at least a user identification information and a user text string;
parse the user text string into a plurality of tokens;
analyze the plurality of tokens to determine a user text string classification, the analysis capable of identifying at least one user text string classification identifier token among the plurality of tokens when such an at least one user text string classification identifier token is present, and of otherwise classifying the user text string based on an identification of token types of the plurality of tokens; and
perform a response action based on the user text string classification and at least one token of the plurality of tokens, the response action including at least storing the at least one token of the plurality of tokens in a user database.

50. A processor-implemented system for responding to user text string queries, comprising:
means to receive a user input information, the user input information including at least a user identification information and a user text string;
means to parse the user text string into a plurality of tokens;
means to analyze the plurality of tokens to determine a user text string classification, the analysis capable of identifying at least one user text string classification identifier token among the plurality of tokens when such an at least one user text string classification identifier token is present, and of otherwise classifying the user text string based on an identification of token types of the plurality of tokens; and
means to perform a response action based on the user text string classification and at least one token of the plurality of tokens, the response action including at least storing the at least one token of the plurality of tokens in a user database.
